(19) United States
(12) Patent Application Publication
(10) Pub. No.: US 2024/0347919 A1
(43) Pub. Date: Oct. 17, 2024

(54) Compact Integral Conformal Multi-port Antenna for Wireless Communications

(71) Applicant: Everest Networks, Inc., Mountain View, CA (US)

(72) Inventors: Van Hoang Nguyen, Senneville (CA); Gijo Augustin, Mountain View, CA (US)

(21) Appl. No.: 18/634,144

(22) Filed: Apr. 12, 2024

Related U.S. Application Data
(60) Provisional application No. 63/459,182, filed on Apr. 13, 2023.

(51) Int. Cl. H01Q 9/28; H01Q 9/04; H04B 7/0413

(52) U.S. Cl. CPC H01Q 9/285; H01Q 9/0414; H04B 7/0413

(57) ABSTRACT

A compact integral conformal antenna system, and methods for fabricating the compact integral conformal antenna system, are described. Also described are use cases of the compact integral conformal antenna system in a wireless device which includes multiple multiple-input multiple-output (MIMO) and/or multi-user multiple-input multiple-output (MU-MIMO) capable radios.

### CLAIM OF PRIORITY

This application claims priority to U.S. Provisional Application Ser. No. 63/459,182, filed on Apr. 13, 2023, the entire contents of which are hereby incorporated by reference.

### TECHNICAL FIELD

This application discloses methods to construct an integral conformal antenna system for use in a wireless device which includes multiple multiple-input multiple-output (MIMO) and/or multi-user multiple-input multiple-output (MU-MIMO) capable radios.

### BACKGROUND

Modern wireless devices comprise one or more radios, where some or all of those radios comprise multiple radio frequency (RF) ports, where each RF port transmits or receives a RF signal. RF ports attached to a same radio transmit RF signals in a RF channel occupying a limited bandwidth. Different radios transmit in different RF channels. An example of such a radio is a radio supporting multiple input multiple output (MIMO) or multi-user MIMO (MU-MIMO) transmission techniques where multiple spatial streams (SS) of data are transmitted simultaneously over the wireless medium to increase the aggregate spectral efficiency.

The RF ports are coupled to antennas which can radiate the signals over the wireless medium. Several types of antennas can be employed providing omni-directional, directional or reconfigurable radiation patterns, and various radiation polarization. As the number of RF ports and radios inside a wireless device increase, it becomes challenging to integrate the required number of antennas inside the wireless device. For example, a radio with 8 RF ports supporting an 8×8 MIMO configuration requires 8 antenna elements. Furthermore, several considerations must be considered to provide efficient MIMO and MU-MIMO transmissions, such as antenna spacing, radiation pattern diversity, and polarization diversity. In addition, other considerations such as antenna coupling to enable multiple radios seamless operation and antenna directionality for high density deployment should be considered to enable the design of efficient wireless devices. Conventional antennas cannot meet all the above requirements in a compact form factor required for the design of multi-radio MIMO/MU-MIMO wireless devices.

### SUMMARY

This application discloses novel methods to construct compact integral conformal antenna systems for multi-radio MIMO/MU-MIMO wireless devices.

Details of one or more implementations of the disclosed technologies are set forth in the accompanying drawings and the description below. Other features, aspects, descriptions and potential advantages will become apparent from the description, the drawings and the claims.

### BRIEF DESCRIPTION OF THE DRAWINGS

FIG. 1 is a diagram of a multi-radio wireless network device (MR-WND).

FIGS. 2A-2C show aspects of a multi-radio wireless network device that includes an antenna system in accordance with the disclosed technologies.

FIG. 3 is a diagram of an example of a multi-segment multi-port (MSMP) antenna.

FIG. 4 is a diagram of a wireless network device which includes a single radio with four RF chains and an antenna system that includes four planar antenna segments.

FIGS. 5A-5B show aspects of an example of a dual linear polarization microstrip patch antenna.

FIGS. 6-7 show aspects of an embodiment of an MSMP antenna which includes four planar antenna segments, each of which implemented as single dual linear polarization microstrip patch antenna.

FIG. 8 is a diagram of an MSMP antenna system which includes an interface matrix and a four-segment multi-port antenna, where the interface matrix connects four RF chains of a radio to the four antenna segments using a configurable interconnecting arrangement.

FIG. 9 is a diagram of an MSMP antenna system which includes an interface matrix and a four-segment multi-port antenna, where the interface matrix connects eight RF chains of a radio to the four antenna segments using a fixed interconnecting arrangement.

FIG. 10 is a diagram of an MSMP antenna system which includes an interface matrix and an eight-segment multi-port antenna, where the interface matrix connects eight RF chains of a radio to the eight antenna segments using either a fixed or a configurable interconnecting arrangement.

FIG. 11 is a diagram of a multi-radio wireless network device which includes two radios each with four RF chains and an MR-MSMP antenna system that includes two MSMP antennas each with four planar antenna segments.

FIGS. 12-13 show aspects of an embodiment of an MR-MSMP antenna structure which includes two MSMP antennas each with four planar antenna segments, each of which implemented as single dual linear polarization microstrip patch antenna.

FIG. 14 shows an example of an arrangement on a PCB of two planar antenna segments, each of which implemented as single dual linear polarization microstrip patch antenna, of respective two MSMP antennas.

FIG. 15 is a diagram of an MR-MSMP antenna system which includes an interface matrix and two MSMP antennas each having four planar antenna segments, where the interface matrix connects four RF chains from each of two radios to the respective four antenna segments of the MSMP antennas using a configurable interconnecting arrangement.

FIG. 16 is a diagram of an example of an integral conformal antenna system.

FIGS. 17-18 show aspects of an embodiment of the integral conformal antenna system from FIG. 16.

FIG. 19 is a diagram of an example of a MR-WND including one or more integral conformal antenna systems.

FIG. 20 is a diagram of an example of a MR-WND including multiple radios and multiple integral conformal antenna systems in which each radio is coupled with a respective integral conformal antenna system.

FIG. 21 is a diagram of an example of a MR-WND including multiple radios and a single integral conformal antenna system in which each radio is coupled with the integral conformal antenna system.

FIG. 22 is a diagram of an example of a MR-WND including multiple radios and multiple integral conformal antenna systems in which some radios are coupled with different integral conformal antenna systems.

FIG. 23 is a diagram of an example of an integral conformal antenna system coupled with one radio having up to 8 RF chains.

FIGS. 24-26 show aspects of an embodiment of the integral conformal antenna system from FIG. 23.

FIGS. 27A-27B show aspects of a process for fabricating the integral conformal antenna system of FIGS. 24-26.

FIG. 28 is an image of an example of an integral conformal antenna system fabricated using the process of FIG. 27A.

FIG. 29 shows two coverage scenarios for a ceiling mounted MR-WND which includes an integral conformal antenna system.

FIG. 30 is a diagram of another example of a MR-WND including multiple radios and a single integral conformal antenna system in which each radio is coupled with the integral conformal antenna system, and has the same number of RF chains as the other radios.

FIG. 31 shows an embodiment of the integral conformal antenna system of the MR-WND from FIG. 30.

FIG. 32 is a diagram of an example of another example of a MR-WND including multiple radios and a single integral conformal antenna system in which each radio is coupled with the integral conformal antenna system, and has a different number of RF chains compared to the other radios.

FIG. 33 shows an embodiment of the integral conformal antenna system of the MR-WND from FIG. 32.

Like reference symbols in the various drawings indicate like elements.

Certain illustrative aspects of the disclosed technologies are described herein in connection with the following description and the accompanying figures. These aspects are, however, indicative of but a few of the various ways in which the principles of the disclosed technologies may be employed and the disclosed technologies are intended to include all such aspects and their equivalents. Other advantages and novel features of the disclosed technologies may become apparent from the following detailed description when considered in conjunction with the drawings.

### DETAILED DESCRIPTION

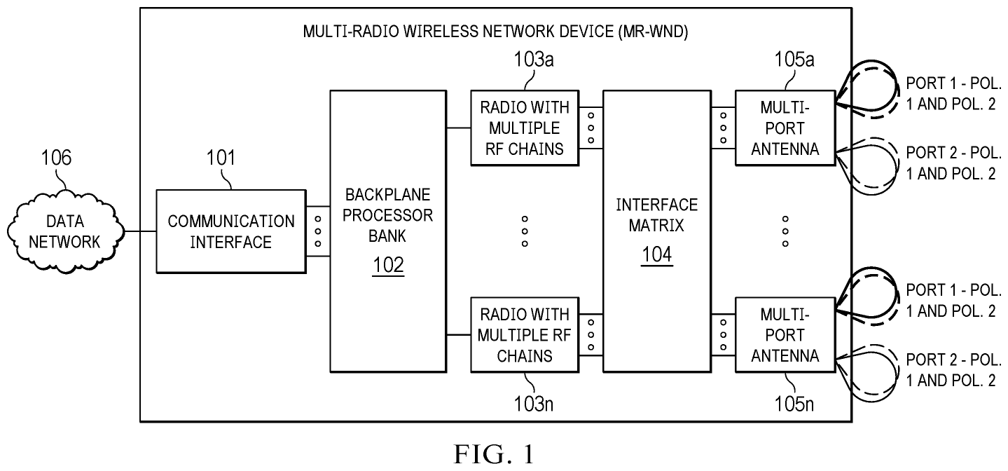

This application discloses methods to construct a compact integral conformal antenna system for use in a multi-radio wireless network device (MR-WND), such as the example MR-WND illustrated in FIG. 1.

The MR-WND can include a communication interface 101, backplane processor bank 102, multiple radios 103a-103n each with multiple radio RF transceiver chains (example of such radios include MIMO (multiple-input multiple-output) and MU (multi-user)-MIMO radios), an interface matrix 104 and multiple multi-port antennas 105a-105n. MR-WND can be used as an access point or base station. The multi-port antennas 105a-105n have at least two ports and can simultaneously transmit multiple beams to increase the aggregate spectral efficiency. Each port transmits or receives a RF signal. Ports attached to a same radio transmit RF signals in a RF channel occupying a limited bandwidth. Each beam, also referred to as a spatial stream (SS) of data, may radiate the same or different RF signal and each beam has different signal polarization and/or radiation pattern (a radiation pattern is mainly characterized by the maximum gain direction and its beamwidth). Several types of antennas can be employed providing omnidirectional, directional or reconfigurable radiation patterns, and various radiation polarizations. The interface matrix 104 interconnects the RF signals from the radios 103a-103n to the multi-port antennas ports 105a-105n. Optionally, the interconnection can be dynamically configured.

Prior to describing example implementations of a compact integral conformal antenna system, in the following sections we address the design and implementation of an antenna system that provides efficient MIMO and MU-MIMO communications concurrently with multiple radios in UHD environments. The antenna system would itself be a composite of a plurality of directional antennas, together with other RF elements, configured so as to achieve this result. We discuss our embodiments of the antenna system, as a composite of a plurality of various RF elements. In particular, the antenna system comprises preferentially a plurality of directional antennas, as opposed to omni-directional antennas. Directional antennas, by their nature, provide means to reject deleterious signals presenting as interference from outside the coverage area. In the embodiments disclosed herein, the antenna system is defined such that it can achieve the feature attributes required of the WND, in a manner that is compact, and addresses the multitude of physical challenges that arise from its integration. We address both use cases, identified above, where either a wide coverage area or a narrow coverage area with high antenna gain and directivity are required. The disclosed antenna systems thus enable the deployment of high capacity wireless networks for a wide variety of UHD environments. The disclosed antenna system can optionally incorporate means to reconfigure an interface matrix to enable dynamic coverage and interference management of the different radios.

The methods described herein can be used to implement an antenna system with the following features/aspects (important to UHD type environments): (1) means to radiate for at least two radios and at least two RF signals per radio with orthogonal polarization everywhere in the intended coverage zone of each radio of the wireless network device to efficiently support MIMO communications in UHD environments; (2) means to provide coverage in an area while reducing signal leakage and increasing signal rejection to/from adjacent WND in order to provide good connectivity in the coverage area while decreasing the channel reuse distance; and (3) sufficient isolation between radios to enable concurrent radio transmission and reception. In the result, we consider desirable, but not limiting, attributes arising from two MR-WND coverage use cases typified in UHD environments. In the first case, coverage in a relatively wide area is desired.

More specifically, the coverage beamwidth should be between 90 degrees and 160 degrees. This feature is to provide coverage in large areas, such as conference halls, stadium or airport concourses, etc. In the second case, a relatively small coverage with a narrow beam and high signal gain is desired. More specifically, the coverage beamwidth should be smaller than 60 degrees with more than 6-dBi gain and low side lobe levels. This feature is to provide coverage from locations far from users, such as in a stadium or arena bowl seating area.

Additional desirable optional features that are incorporated include: (1) means to radiate for some radios at least four RF signals, where two RF signals radiate in a given direction with a given beamwidth with orthogonal polarization and the two other RF signals radiate in a different direction and/or different beamwidth with orthogonal polarization with respect to the first two RF signals. This feature helps decorrelate the wireless link and enhances MU-MIMO transmission in UHD environments to distinct users via pattern diversity; (2) means to independently reconfigure the intended coverage direction and/or intended coverage area of some of the radios, in order to dynamically reassign radio capacity where required relative to the wireless network device location, and/or decrease RF interference in/from given directions. A particularly desirable feature is to reassign the capacity of all radios in the same coverage zone or in different coverage zones, and; (3) the antenna system has a small conformal or planar form factor. This feature is required to design aesthetic wireless network devices.

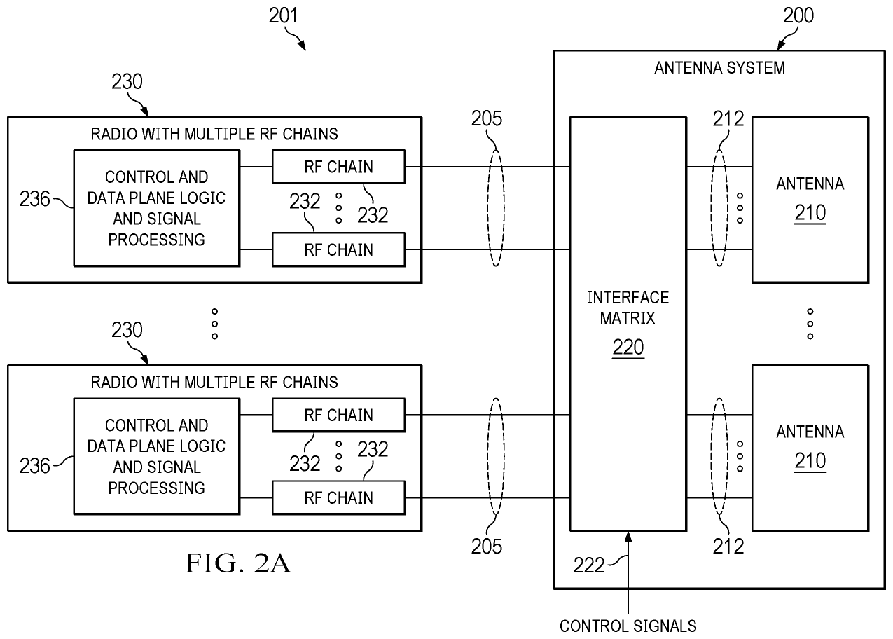

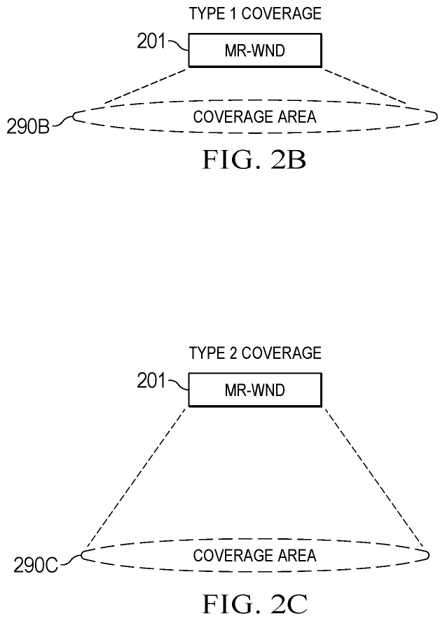

FIG. 2A is a diagram of an antenna system 200 that includes multiple antennas 210 and an interface matrix 220 for a MR-WND 201 that comprises at least two radios 230, each radio with multiple radio transceiver chains 232 (also referred to as RF chains). Examples of such radios 230 include MIMO and MU-MIMO radios. In the WND 201, each RF chain 232 of a radio 230 transmits on the same RF channel RF signals 205 belonging to the same data channel. The RF signals 205 can be the same or different. For clarity in the following we will assume that RF signals 205 are different. Each radio 230 transmits and receives RF signals 205 in one or more RF channels within an operating RF band. The RF band itself consists of RF spectrum that divided into multiple RF channels. The RF channels can be non-contiguous and the RF band may consist of non-contiguous RF spectrum. For clarity, in the following we will assume a single RF channel. Different radios transmit and receive RF signals 205 in RF channels in substantially non-overlapping RF bands. The RF chains of the radios 230 connect through the interface matrix 220 to the ports 212 of the multiple antennas 210. The interface matrix 220 could be reconfigured to selectively interconnect the RF chains 232 to the antenna ports 212 to dynamically change the spatial coverage of said radios 230. FIG. 2A illustrates an example of an interconnection of the radios 230, interface matrix 220 and antennas 210 in the MR-WND 201. In general, the number of radios 230 may differ from the number of antennas 210, and a radio can be connected simultaneously to different antennas.

The interface matrix 220 may comprise cables, transmission lines, switching elements and/or power dividing/combining elements to selectively route and connect or disconnect the RF chains 232 to each of the individual antenna feeds. Furthermore, the interface matrix 220 can be configured to allow each RF chain 232 to be coupled to none, one or multiple antenna feeds of the antenna system 200. The state of the switching elements is dynamically configured via the interface matrix control signals 222. The interface matrix 220 can also include RF filters to further reject signals outside the radio's operating RF band. Furthermore, the interface matrix 220 may comprise multiple separate interface matrix modules implemented on separate PCB.

Here, each radio 230 in the wireless network device 201 communicates data wirelessly according to communication protocols, such as those specified by IEEE 802.11, LTE (and its variants, LTE-U, MuLTEfire, etc.), IEEE 802.15.4 (Zigbee), Bluetooth, and/or other type of wireless communication protocols. Different radios 230 can operate according to different user desired protocols. The radios 230 can also be multiple protocol capable, to be reconfigured to operate using different communication protocols. In the discussion that follows, for clarity, IEEE 802.11ac with four antennas is often used as an illustrative example. However, this does not restrict the scope of the described technologies and their applicability to particular radios or particular communication protocols.

The system logic 236 to determine the control signals 222 required to configure the coupling state realized by the interface matrix 220 can be implemented in either the radios 230, or a processor in a processor bank attached to the radios or a separate entity in the data network attached to a wireless network device communication interface such as a different wireless network access device or a wireless network access controller, or a combination of the above.

As discussed above, UHD deployments environments are best addressed using an antenna system 200 with either low gain and directivity providing wide coverage area (also referred to as UHD type-1 or simply type-1) or high gain and directivity providing narrow coverage area (also referred to as UHD type-2 or simply type-2). FIGS. 2B and 2C illustrate, without limitation, type 1 coverage area 290B and type 2 coverage area 290C, respectively. An example of type-1 coverage 290B is encountered in deployment of a ceiling mount MR-WND 201 at a height of less than 15 feet while an example of type-2 coverage 290C is encountered in deployment of a MR-WND 201 on a canopy or catwalk to serve users at a distance circa 100 feet. In the absence of a single antenna system that provides ideal capability for both type-1 and type-2 use cases we disclose two approaches to realizing an antenna system, one for UHD type-1 and one for UHD type-2, with each approach itself consisting of two steps. Although both antenna systems differ in their specific composition, the high-level elements of both antenna systems are common to the ones of the antenna system 200 illustrated in FIG. 2A.

In the first approach, we describe in a first step a first antenna system comprising a multi-segment multi-port (MSMP) antenna and an interface matrix for a WND having one radio. This MSMP antenna system provides means to the radio to cover a wide area as per UHD type-1. In a second step, we describe how to extend the MSMP antenna system to a MR-WND comprising at least two radios. This MR-WND employing a multi-radio MSMP antenna system comprising multiple MSMP antennas is suitably the first solution approach to provide coverage in type-1 wide areas.

In the second approach, we describe in a first step an antenna system comprising a Multi-Port Array (MPA) antenna and an interface matrix for a WND having one radio. This MPA antenna provides high gain and high directivity to provide adequate service to users from a large distance as per UHD type-2. In a second step, we describe how to extend the MPA antenna system to a MR-WND comprising at least two radios. This MR-WND employing MPA antennas is suited for UHD type-2 environments.

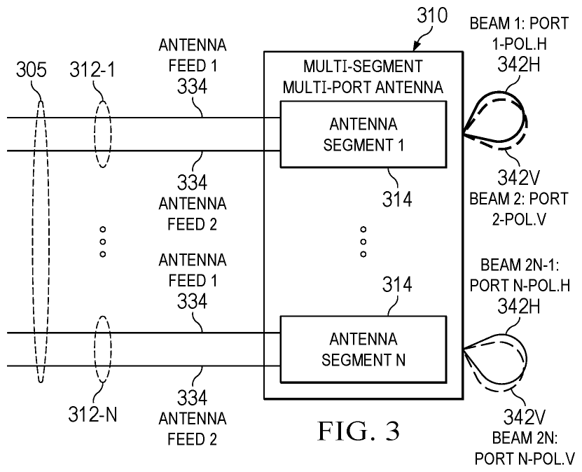

FIG. 3 illustrates the concept of an MSMP antenna 310 and its interface to a radio with multiple RF radio chains. The MSMP antenna 310 comprises multiple antenna segments 314 wherein each antenna segment has a common antenna port 312 comprising two separate antenna feeds 334 and means to radiate RF signals coupled to the antenna feeds with a directional radiation pattern. Further, each antenna segment 314 in the MSMP antenna 310 is a planar structure than can be independently oriented from the other segments (that is, the normal to each antenna segment plane can be positioned in independent directions). Each antenna feed 334 can be connected, through the interface matrix (e.g., 220), to a RF chain of the radio. Each RF chain transmits/receives a RF signal 305 from a radio.

Generally, a RF chain can be interconnected to none, one or more than one antenna feed 334 and an antenna feed can be connected to none, one or more than one RF chain. RF signals 305 coupled to the two different RF antenna feeds 334 of a common antenna port 312 are radiated by the antenna segment 314 with two different directional (non-omnidirectional) beams 342H, 342V. Both directional beams 342H, 342V radiate the RF signals with substantially similar radiation patterns, but with orthogonal polarizations. We refer to these dual beams as the vertical polarization beam 342V and horizontal polarization beam 342H of the antenna port 312 or antenna segment 314. In the result, each port 312 of the MSMP antenna 310 provides means to radiate a pair of directional beams 342H, 342V with orthogonal polarization in substantially different directions from the other ports 312. The antenna segment 314's properties (planar structure, independent geometric arrangement of different antenna segments, directional beam, two antenna feed, orthogonal polarization) make the MSMP antenna system, as we disclose later, an excellent choice to achieve type-1 coverage 290B with a MR-WND 201.

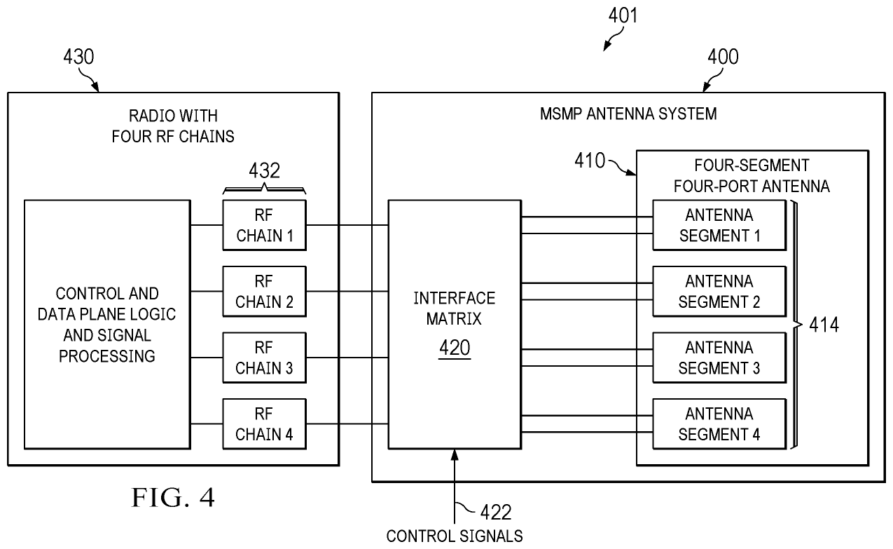

FIG. 4 is a diagram of an MR-WND 401 that uses an MSMP antenna system 400. For sake of clarity, and without limitation, the embodiment of the MR-WND 401 has one radio with four RF chains 432. The MSMP antenna system 400 comprises an MSMP antenna 410 and an interface matrix 420, with the MSMP antenna consisting of four planar antenna segments 414. Somebody skilled in the art can easily extend the embodiment of the MR-WND 401 having a single radio 430 to different number of radios, RF chains, MSMP antennas, planar antennas per MSMP antenna, etc. In the example illustrated in FIG. 4, the MSMP antenna 410 consists of four distinct planar antenna segments 414. Each planar antenna segment 414 is fabricated on a separate printed circuit board (PCB). The planar antenna segments 414 can also be designed to have a low reflection coefficient in a given operating frequency band and a high reflection coefficient outside the band. As will be shown, this becomes an important enabler for multi-radio operations.

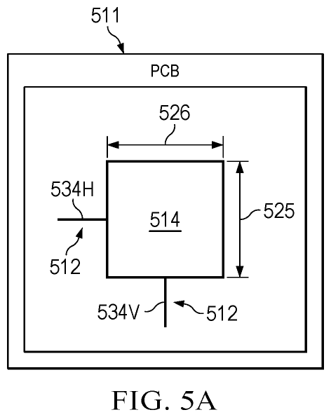

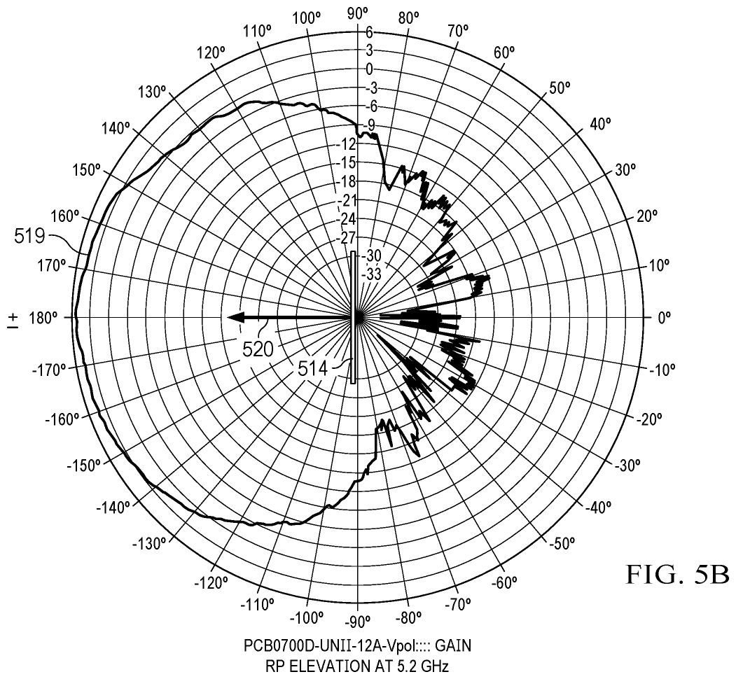

FIG. 5A shows an example of a planar antenna segment 414 implemented here as a dual linear polarization microstrip patch antenna 514 fabricated on a PCB 511. FIG. 5B shows an intensity distribution 519 of a fixed directional beam that is emitted by the microstrip patch antenna 514 in the direction normal 520 of the patch antenna 514's plane. Here, the fixed directional beam has a 3-dB beamwidth of approximately 90 degrees (the actual beamwidth depends on the ground plane dimensions). By tuning its width 525 and length 526, the patch antenna 514 can be designed to have a low reflection coefficient in a given operating frequency band and a high reflection coefficient outside the band. The dual linear polarization microstrip patch antenna 514 has two antenna feeds, and the two feeds 534H, 534V together constitute the planar antenna segment port 512. By appropriately connecting the antenna feeds 534H, 534V to the patch antenna, the single patch antenna 514 can simultaneously radiate two different RF signals with vertical and horizontal polarization.

Multiple microstrip patch antennas 514 can also be fabricated on a single PCB so as to construct multiple MSMP antennas for a MR-WND. Another example of a planar antenna segment that can be employed in this manner is a stacked patch antenna. In all the considered arrangements, the multiple planar antenna segments of the MSMP antenna are oriented on non-parallel planes. That is, the normal 520 to each planar antenna segment is oriented in a different direction. Therefore, RF signals coupled to different ports of the MSMP antenna will simultaneously radiate with different beams having different directions.

Referring now to FIGS. 4 and 5A, the interface matrix 420 provides means to interconnect the different RF chains 432 of the radio 430 to one or more antenna feeds 534H, 534V of the planar antenna segments 414, 514. The interface matrix 420 can further include means to dynamically reconfigure the interconnections between the multiple RF radio chains 432 and the multiple antenna ports 512. In generality, the interface matrix 420 can be configured to allow each RF chain 432 to be coupled to none, one or multiple planar antenna segments 414, 514 of the MSMP antenna 410. In the result, by appropriately designing the geometry of the planar antenna segments 414, 514 of the MSMP antenna 410 and selectively interconnecting RF chains 432 of the radio 430 to the antenna feeds 534H, 534V on the planar antenna segments 414, 514, it is possible to achieve multiple well-controlled coverage areas for the radio 430 with the same MSMP antenna 410. The interface matrix 420 in this arrangement can also implement the further function and means to reject or improve the rejection of signals outside a given band. RF filters, which are devices providing low insertion loss in a given RF band (the RF band may consist of contiguous or non-contiguous RF spectrum) and high signal rejection outside this band, will be often used in the following exemplary embodiment as a mean to provide this function in the interface matrix 420.

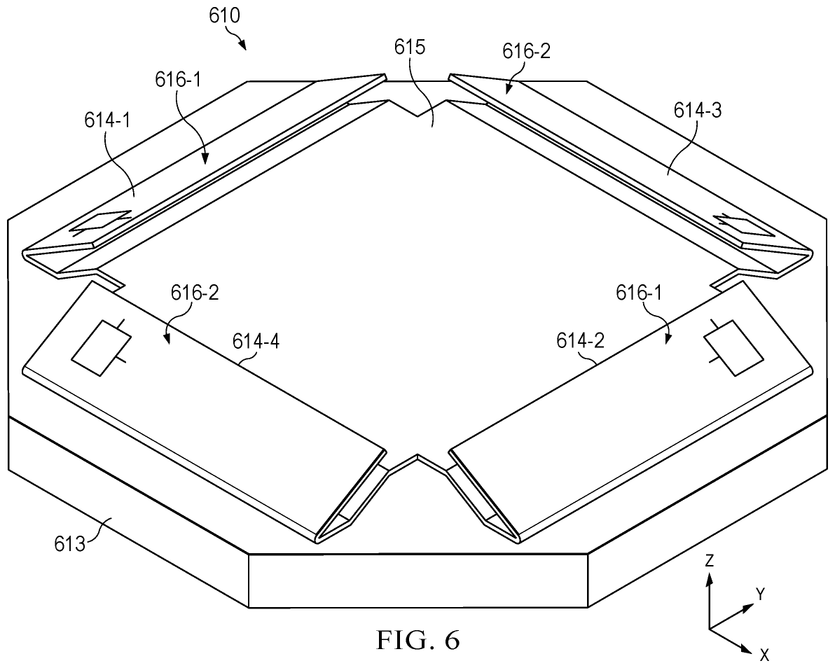

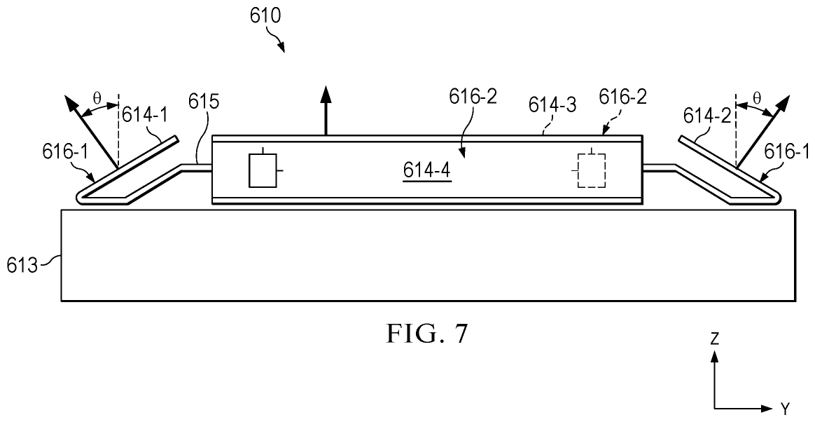

FIG. 6 is a perspective view, and FIG. 7 is a side view into the (y,z)-plane, of an embodiment of an MSMP antenna 610 configured as a geometrical circuit arrangement comprising four planar antenna segments 614-1, 614-2, 614-3, 614-4, each of which implemented as the dual linear polarization microstrip patch antenna 514 of FIG. 5. Note that the side view into the (x, z)-plane of the MSMP antenna 610 is similar to the one illustrated in FIG. 7. The MSMP antenna 610 is supported on a chassis 613 (which can be the housing of the MR-WND 401, for instance) and includes a base 615 and the four planar antenna segments 614-1, 614-2, 614-3, 614-4. In the example illustrated in FIGS. 6-7, the base 615 has a surface parallel to the (x, y)-plane that represents a reference plane for the geometrical circuit arrangement of the MSMP antenna 610. The four planar antenna segments 614-1, 614-2, 614-3, 614-4 are assembled on the base 615 as illustrated in FIGS. 6-7. A first pair 616-1 of two planar antenna segments 614-1, 614-2 are arranged such that their respective normals have the same angle θ with a reference plane normal (the XY plane). For the case where the planar antenna segments are microstrip patch antennas, a range of values for angle θ is 10° to 40°, with a preferred value for this angle being θ=30°. Furthermore, a first plane (the YZ plane) defined by the normals of the first pair 616-1 of two planar antenna segments 614-1, 614-2 is orthogonal to the reference plane 613 (the XY plane). A second pair 616-2 of two planar antenna segments 614-3, 614-4 are arranged such that their respective normal has the same angle θ with a reference plane (the XY plane) as the first two planar antenna segments 614-1, 614-2. Furthermore, the second plane (the XZ plane) defined by the normals of the second pair 616-2 of two planar antenna segments 614-3, 614-4 is orthogonal to the reference plane (the XY plane), and is orthogonal to the first plane (the YZ plane) defined by the normals of the first pair 616-1 of two planar antenna segments 614-1, 614-2. FIG. 5 furthers shows that the respective horizontal (or vertical, as the case may be) antenna feeds 534H, 534V of the different antenna segments 614-1, 614-2, 614-3, 614-4 are co-aligned. This arrangement is preferable in the embodiment 610, as symmetry of the resulting composite RF pattern from the antenna system 400 is desirable in this embodiment, but for generality the antenna feeds 534H, 534V of the different antenna segments 614-1, 614-2, 614-3, 614-4 need not be so aligned.

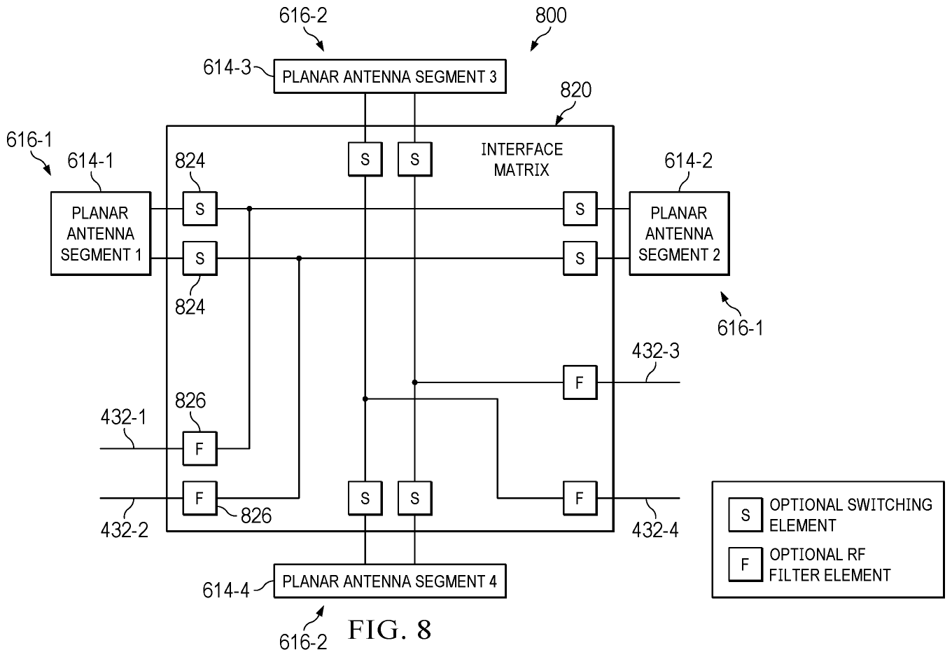

FIG. 8 is a diagram of an MSMP antenna system 800 comprising an interface matrix 820 between the four RF chains 432-1, 432-2, 432-3, 432-4 of the radio 430 and the eight antenna feeds of the four antenna segments 614-1, 614-2, 614-3, 614-4 of the MSMP antenna 610 illustrated in FIG. 6 and FIG. 7. A first RF chain 432-1 of the radio 430 is interconnected through the interface matrix 820 to a first antenna feed 534H, 534V on a first planar antenna segment 614-1 of the first pair 616-1 of two opposite planar antenna segments 614-1, 614-2 and to a first antenna feed 534V, 534H on a second planar antenna segment 614-2 of the first pair 616-1 of two opposite planar antenna segments 614-1, 614-2. Therefore, the RF signal from the first RF chain 432-1 will radiate with different beams in different directions from both planar antenna segments 614-1, 614-2. Note that the two antenna feeds 534H, 534V, one to each of the opposite planar antenna segments 614-1, 614-2, can be selected such that they radiate the same signal with either the same or different polarization. A second RF chain 432-2 of the radio 430 is interconnected in a similar manner through the interface matrix 820 to each of the two ports 512 of the first pair 616-1 of two planar antenna segments 614-1, 614-2, but to antenna feeds other than the antenna feeds 534H, 534V interconnected to the first RF chain 432-1. A third and fourth RF chains 432-3, 432-4 of the radio 430 are interconnected through the interface matrix 820 to the second pair 616-2 of two planar antenna segments 614-3, 614-4 in a similar manner as the first and second RF chains 432-1, 432-2.

The interface matrix 820 can further include switching elements(S) 824 to dynamically and independently interconnect or disconnect each RF chain 432-1, 432-2, 432-3, 432-4 to each of the antenna feeds 534H, 534V. The interface matrix 820 then enables the reconfiguration of the radio coverage area, including its direction and width. The state of the switching elements 824 is dynamically configured via the interface matrix control signals 422. The interface matrix 820 can also include inline RF filters (F) 826 to further reject signals outside the desired operating frequency band.

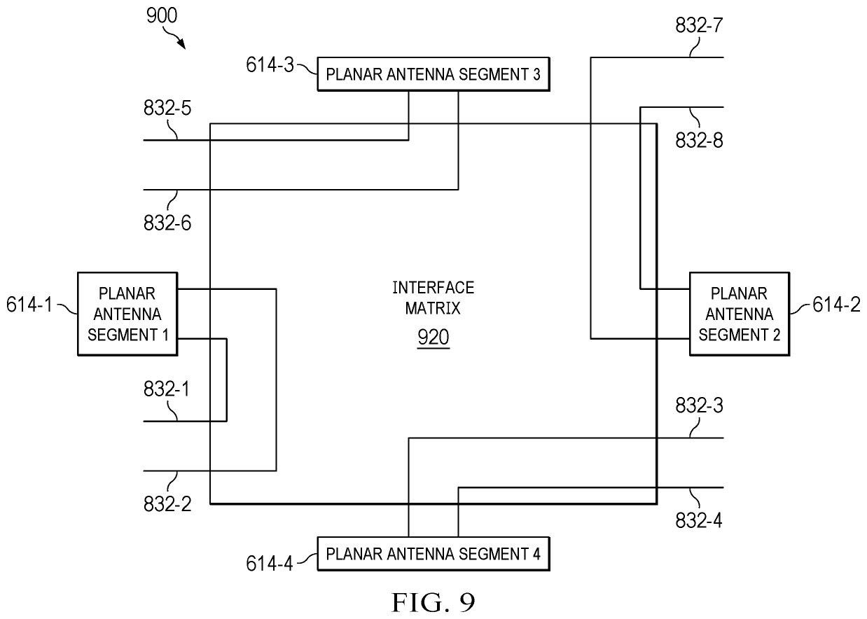

One skilled in the art can easily extend this exemplary embodiment of antenna system 800 to be used with radios with a smaller or larger number of RF chains. FIG. 9 is a diagram of an MSMP antenna system 900 comprising an interface matrix 920 between eight RF chains 832-1, . . . , 832-8 of a radio and the eight antenna feeds of the four planar antenna segments 614-1, 614-2, 614-3, 614-4 of the MSMP antenna 610 illustrated in FIG. 6 and FIG. 7. The eight antenna feeds of the MSMP antenna 610 can be interconnected with the eight RF chains 832-1, . . . , 832-8 of the radio using a fixed arrangement of the interface matrix 920, as illustrated in FIG. 9. This fixed arrangement of the interface matrix 920 provides all the required features, except providing means through the interface matrix 920 to reconfigure the coverage area.

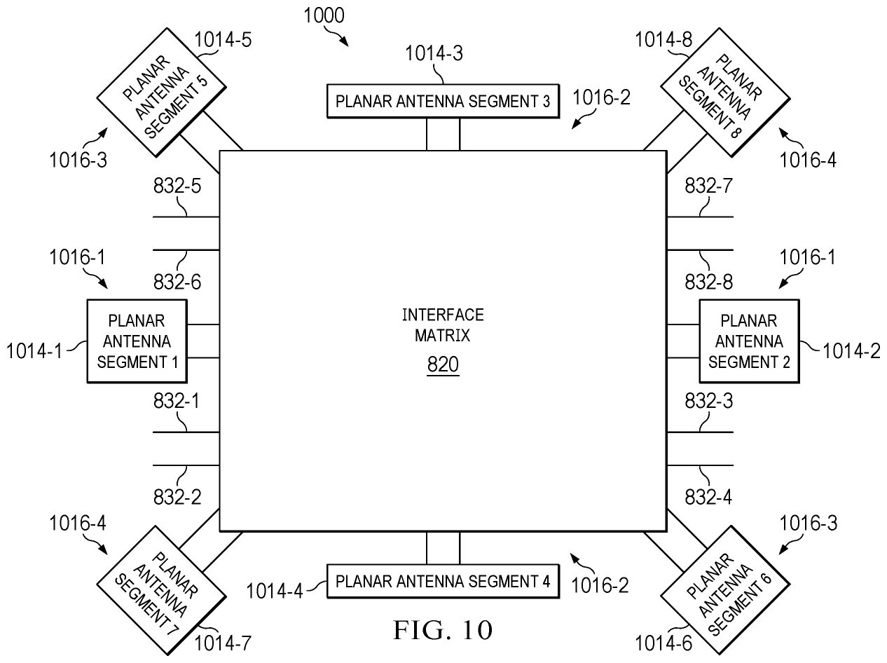

FIG. 10 is a diagram of an MSMP antenna system 1000 comprising an interface matrix 1020 between eight RF chains 832-1, . . . , 832-8 of a radio and sixteen antenna feeds of eight planar antenna segments 1014-1, . . . , 1014-8 of an MSMP antenna. The eight-segment multi-port antenna, having planar antenna segments 1011-1, . . . , 1014-8, can be interconnected with the eight RF chains 832-1, . . . , 832-8 of the radio using an interface matrix 1020, as shown in FIG. 10. The interconnection between the antenna feeds 534H, 534V and RF chains 832-1, . . . , 832-8 is similar to the arrangement with the radio with four RF chains illustrated in FIG. 8. To be more specific, RF chains 832-1 and 832-2, RF chains 832-3 and 832-4, RF chains 832-5 and 832-6, RF chains 832-7 and 832-8, are respectively interconnected through the interface matrix 1020 to the antenna feeds 534H, 534V of the first, second, third and fourth pair 1016-1, . . . , 1016-4 of planar antenna segments, where first, second, third and fourth pair 1016-1, . . . , 1016-4 of planar antenna segments respectively consist of planar antenna segments 1014-1 and 1014-2, planar antenna segments 1014-3 and 1014-4, planar antenna segments 1014-5 and 1014-6, and planar antenna segments 1014-7 and 1014-8. If the interface matrix 1020 further includes switching elements to dynamically and independently interconnect or disconnect each RF chain 832-1, . . . , 832-8 to each of the antenna feeds 534H, 534V, it then become possible to selectively reconfigure the coverage area, including its profile, direction and width, obtainable by the radio with eight RF chains 832-1, . . . , 832-8.

One can appreciate that by employing similar microstrip patch antennas 514 in the multiple segments, the composite radiated signal level, or coverage pattern of the MSMP antenna system 400, 800, 900, 1000 is substantially axially symmetric and uniform in the entire coverage area. This is a desirable and specifically intended feature and benefit of this arrangement, in order to provide uniform service to a plurality of client devices wherever they are located in the type-1 coverage area.

Other benefits and features of the arrangement of antenna system 400, 800, 900, 1000 are: (1) it is possible to achieve various alternate coverage patterns for the radio varying from an approximately 90×90 degree sector coverage to 160×160 degree sector coverage by selectively interconnecting the RF chains to the antenna feeds in the interface matrix 420, 820, 920, 1020; (2) the achievable radiation patterns have maximum gain in front of the MR-WND 401 (along the Z axis) and minimize the signal propagation of signal close or beyond the reference plane (XY plane). This minimizes, as intended, the interference leakage to adjacent wireless network devices and client devices outside the intended service area that may be using the same RF channel; (3) everywhere in the coverage area of the radio, there are always two signals emanating on different beams with orthogonal polarization. This is a desired feature to provide efficient MIMO communication links with two spatial streams in a LOS/quasi-LOS setting; (4) different RF signals are radiated in different directions (e.g., the RF signals from the first and second RF chains 432-1, 432-2 radiate in substantially different directions as the RF signals from the third and fourth RF chains 432-3, 432-4). This provides additional signal discrimination that further enhance the performance of MU-MIMO communications; (5) the MSMP antenna system 400, 800, 900, 1000 has a low profile and can be integrated in a wireless network device 401 with aesthetic design; and (6) as we will explain below, the MSMP antenna system 400, 800, 900, 1000 is suitable for the integration of multiple radios in MR-WND. One can thus appreciate the significant benefits provided by the disclosed MSMP antenna system 400, 800, 900, 1000 over state-of-the-art antenna systems.

We further recognize, in the second step of the first approach for the design of an antenna system for UHD with wide type-1 coverage, the several characteristics possessed by the MSMP antenna system 400, 800, 900, 1000 that are critical for a multiple radio implementation. First, the planar and multi-segment nature of the MSMP antenna makes it amenable to integrate multiple MSMP antennas in a small form factor wireless network device. Second, the MSMP antenna structure makes is possible to conceive a geometric arrangement with interface matrix that enables the coverage properties identified before. Finally, the MSMP antenna has improved intrinsic signal rejection properties which arise from the compounding effects of (1) the directionality and orthogonality of the beams of the various antenna segments, (2) the purposeful and flexible geometric separation and arrangement of the antenna segments and, (3) the optional use of in-line RF filters, enhances the isolation between multiple radios to enable simultaneous operations of the multiple radios.

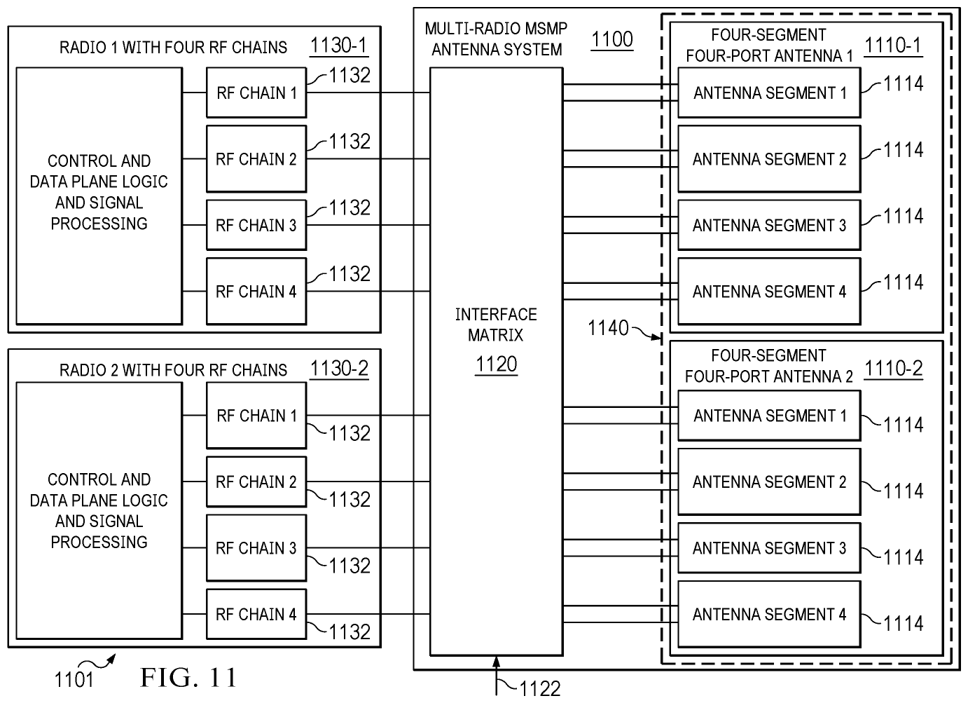

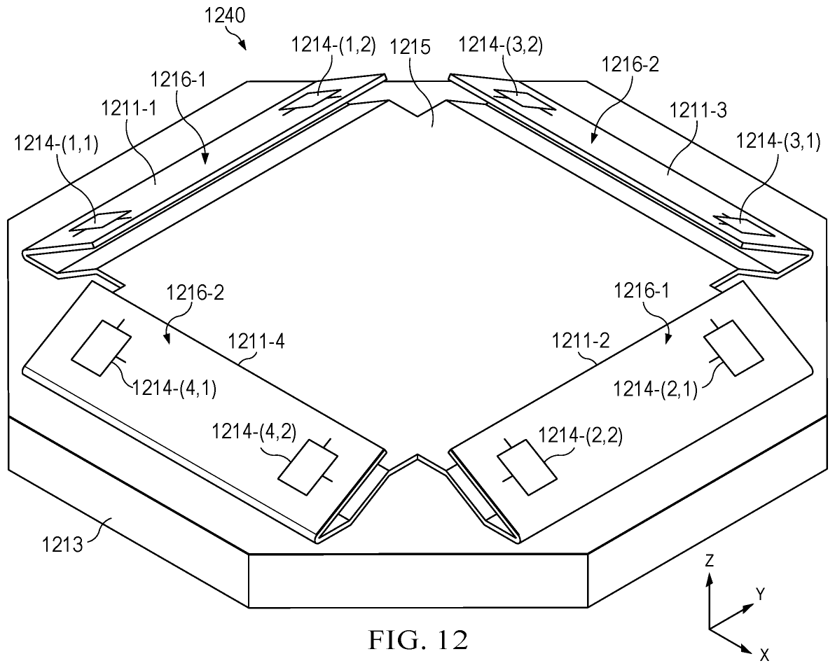

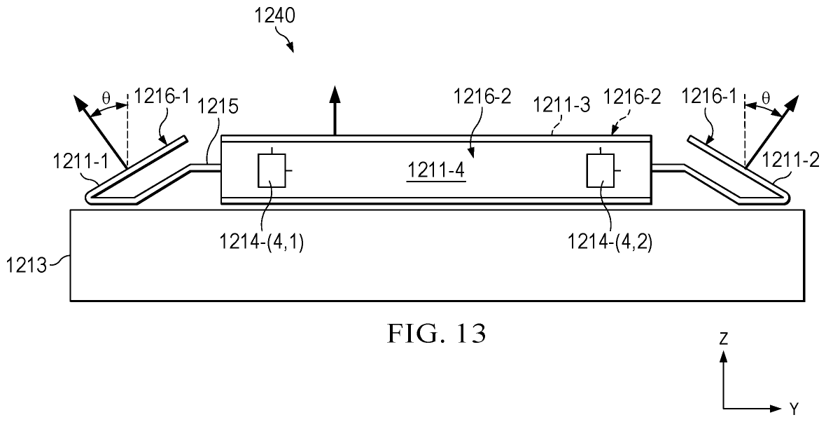

FIG. 11 is a diagram of an MR-WND 1101 that uses a multi-radio MSMP (MR-MSMP) antenna system 1100. For sake of clarity, the MR-WND 1101 has two radios 1130-1, 1130-2 each with four RF chains 1132. The first radio 1130-1 operates on channels in a first band and the second radio 1130-2 operates on channels in a second band. The two bands are mostly non-overlapping. The MR-MSMP antenna system 1100 comprises an interface matrix 1120 and two MSMP antennas 1110-1, 1110-2 each consisting of four planar antenna segments 1114. In other embodiments, the MR-WND 1101 can have a different number of radios, RF chains, and/or can use a different number of MSMP antennas, planar antenna segments per MSMP antenna, etc. Moreover, the MSMP antennas of the MR-MSMP antenna system 1100 can be assembled in an MR-MSMP antenna assembly 1140 described in detail below in connection with FIGS. 12-13.

For the MR-MSMP antenna system 1100, each MSMP antenna 1110-1, 1110-2 includes four distinct planar antenna segments 1114. The MSMP antennas 1110-1, 1110-2 and their respective set of four planar antenna segments 1114 can be arranged to form an MR-MSMP antenna structure 1140 which will be described in detail below in connection with FIGS. 12-13. Each planar antenna segment 1114 of each MSMP antenna 1110 is fabricated on a separate PCB. Note that as will be described below, planar antenna segments 1114 of different multi-segment multi-port antennas 1110 can be fabricated on the same PCB. Each planar antenna segment 1114 is also designed to have a low reflection coefficient in a desired operating frequency band and a high reflection coefficient outside the band to enhance isolation between RF signals of different radios 1130-1, 1130-2. A reflection coefficient is defined as a ratio of the amplitude of the reflected signal to the amplitude of the incident signal. Here, the low reflection coefficient in the desired operating frequency band is designed to be at least 2 to 3 times smaller than the high reflection coefficient outside the band, when measured for a relative frequency separation of 5% to 10%. The relative frequency separation is defined as |f_{L}−f_{H}|/f_{L}+f_{H}×2>100, where f_{L} is the frequency at which the low reflection coefficient is measured, and f_{H} is the frequency at which the high reflection coefficient is measured. Note that the high reflection coefficient is typically 0.85 or larger, 0.9 or larger, 0.95 or larger, or 0.99 or larger. Moreover, the planar antenna segments 1114 of each MSMP antenna 1110-1, 1110-2 are on non-parallel planes. That is, the normal to each planar antenna segment 1114 belonging to the same MSMP antenna 1110-1 or 1110-2 is oriented in a different direction. Therefore, RF signals coupled to different ports of a MSMP antenna 1110-1 or 1110-2 will simultaneously radiate with different beams having different directions.

In general, there are no constraints on the mutual geometric arrangement of the different MSMP antennas 1110-1, 1110-2 in the MR-MSMP antenna structure 1140 of the MR-MSMP antenna system 1100. That is, none, some or all antenna segments 1114 belonging to a different MSMP antenna, e.g., 1110-1, can be parallel to an antenna segment 1114 belonging to a different MSMP antenna, e.g., 1110-2. In a particular arrangement, each antenna segment 1114 of the first MSMP antenna 1110-1 interconnected to the first radio 1130-1's RF chains 1132 is in a plane parallel to the plane of one and only one planar antenna segment 1114 of the second MSMP antenna 1110-2 interconnected to the second radio 1130-2's RF chains 1132 (that is, both planar antenna segment normal are oriented in the same direction). This arrangement leads to several advantages. First, parallel planar antenna segments 1114 of the different MSMP antennas 1110-1 and 1110-2 can be fabricated on a single PCB, leading to lower cost and smaller size. Second, it becomes possible, to conceive and configure an interface matrix 1120 to have coverage area for each radio ranging from mutually fully overlapping to non-overlapping.

The interface matrix 1120 of the MR-MSMP antenna system 1100 provides means to interconnect the different RF chains 1132 of the multiple radios 1130-1, 1130-2 to one or more antenna feeds of the planar antenna segments 1114 of the MSMP antennas 1110-1, 1110-2. The interface matrix 1120 can further include means to dynamically reconfigure the interconnections. By appropriately designing the geometry of the planar antenna segments 1114 and selectively interconnecting RF chains 1132 of each radio 1130-1, 1130-2 to the antenna feeds on the planar antenna segments 1114, it is possible to independently achieve multiple well-controlled coverage area for each radio 1130-1, 1130-2 with the same MR-MSMP antenna system 1100. The interface matrix 1120 can also include means to reject signals outside a given band such as RF filters.

FIG. 12 is a perspective view, and FIG. 13 is a side view into the (y,z)-plane, of an MR-MSMP antenna structure 1240 which includes a base 1215 and a particular circuit arrangement of the two MSMP antennas 1110-1, 1110-2, each with four planar antenna segments 1214, where there are parallel antenna segments from each of the MSMP antennas fabricated on the same PCB 1211. That is, the MR-MSMP antenna structure 1240 comprises four PCBs 1211 and each PCB 1211-j comprises one planar antenna segment 1214-(j,1) of the first MSMP antenna 1110-1 and one planar antenna segment 1214-(j,2) of the second MSMP antenna 1110-2, where j=1, 2, 3, 4. The MR-MSMP antenna structure 1240 is supported by a chassis 1213 (which can be the housing of the MR-WND 1101, for instance). In the example illustrated in FIGS. 12-13, the four PCBs 1211 are assembled on the base 1215, which has a surface parallel to the (x, y)-plane that represents a reference plane for the MR-MSMP antenna structure 1240. Here, the chassis 1215 and the four PCBs 1211 are integrally formed. The four planar antenna segments 1214-(1,1), 1214-(2,1), 1214-(3,1), 1214-(4,1) of the first MSMP antenna 1110-1 are tuned to have a low reflection coefficient in the operating band of the first radio and high reflection coefficient outside the band. Similarly, the four planar antenna segments 1214-(1,2), 1214-(2,2), 1214-(3,2), 1214-(4,2) of the second MSMP antenna 1110-2 are tuned to have a low reflection coefficient in the operating band of the second radio and high reflection coefficient outside the band.

A first pair 1216-1 of two PCB's (PCB 1211-1 and PCB 1211-2) are arranged such that their respective normal has the same angle θ with the reference plane normal (the XY plane). For the case where the planar antenna segments 1214 of the MSMP antennas 1110-1, 1110-2 are microstrip patch antennas (like 514), a range of values for angle θ is 10° to 40°, with a preferred value for this angle being θ=30°. Further, a first plane (the YZ plane) defined by the two normals of the first pair 1216-1 of two PCBs 1211-1, 1211-2 is orthogonal to the reference plane (the XY plane). A second pair 1216-2 of two PCBs (PCB 1211-3 and PCB 1211-4) are arranged such that their respective normal has the same angle θ with a reference plane (the XY plane) as the first pair of two PCB's 1211-1, 1211-2. Further, the second plane (the XZ plane) defined by the two normals of the second pair 1216-2 of two PCBs 1211-3, 1211-4 is orthogonal to the reference plane (the XY plane), and is orthogonal to the first plane (the YZ plane) defined by the two normals of the first pair 1216-1 of two PCB's 1211-1, 1211-2.

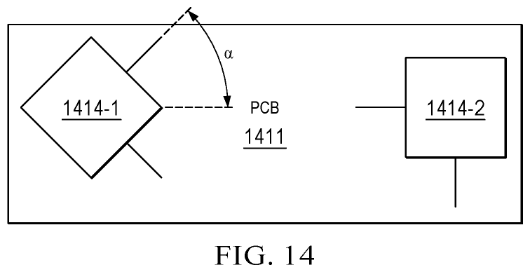

In the case of this particular arrangement of the MR-MSMP antenna structure 1240, to further reduce coupling between the MSMP antennas 1110-1, 1110-2 and improve the isolation between radios 1130-1, 1130-2, it is preferable to alternate the planar antenna segments 1214 order on each adjacent PCB 1211 such that two planar antenna segments 1214 on the same corner are interconnected to RF chains belonging to a same radio 1130. This configuration is illustrated in FIG. 12. Further, FIG. 14 shows a PCB 1411 which supports a planar antenna segment 1414-1 of the first MSMP antenna 1110-1 and a planar antenna segment 1414-2 of the second MSMP antenna 1110-2. The orientation of the planar antenna segments 1414-1, 1414-2 on the PCB 1411 can be optimized to decrease the coupling between the MSMP antennas 1110-1, 1110-2 when the PCBs 1211-1, . . . , 1211-4 of the MR-MSMP antenna structure 1240 are implemented as the PCB 1411. For example, a slant angle α in a range of 30° to 60°, with a preferred value α=45°, can be used between the two planar antenna segments 1414-1, 1414-2 on the PCB 1411, as illustrated in FIG. 14.

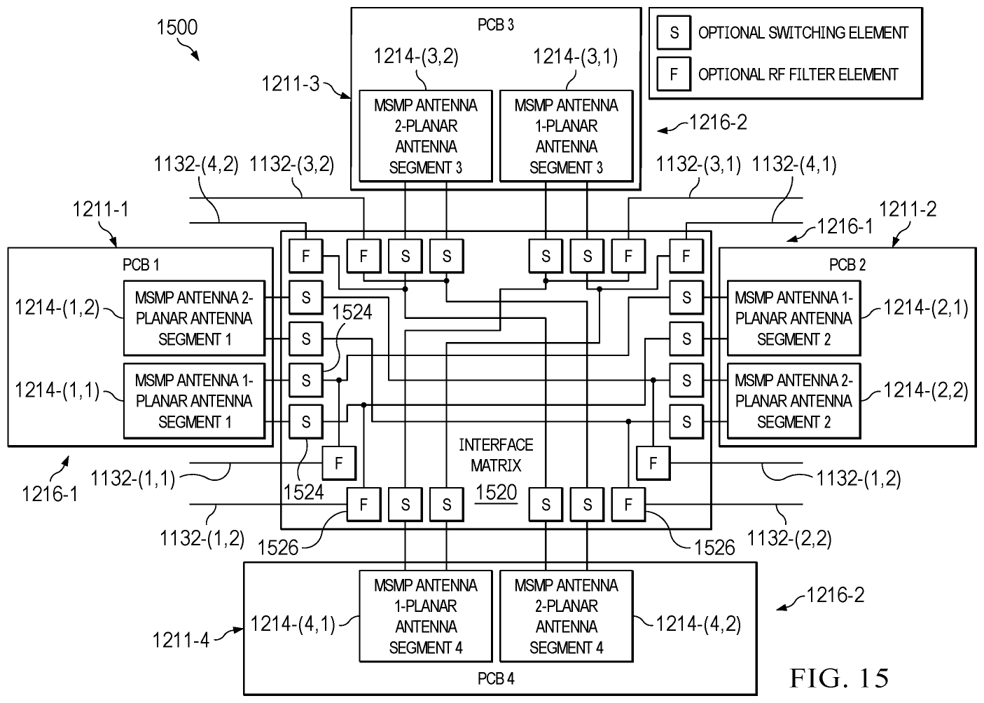

FIG. 15 is a diagram of an MR-MSMP antenna system 1500 comprising an interface matrix 1520 between the eight RF chains 1132-(k, i) of the two radios 1130-i and the sixteen antenna feeds of the two MSMP antennas 1110-i arranged in the MR-MSMP antenna structure 1240 illustrated in FIG. 12 and FIG. 13, where i=1, 2 is a radio/MSMP antenna index, j=1, 2, 3, 4 is a PCB/planar antenna segment index, and k=1, 2, 3, 4 is a RF chain index.

A first RF chain 1132-(1,1) of the first radio 1130-1 is interconnected through the interface matrix 1520 to a first antenna feed 534H, 534V of a first planar antenna segment 1214-(1,1) of a first MSMP antenna 1110-1 fabricated on a first PCB 1211-1 of a first pair 1216-1 of two opposite PCBs 1211-1, 1211-2 and to a first antenna feed 534H, 534V of a second planar antenna segment 1214-(2,1) of a first MSMP antenna 1110-1 fabricated on a second PCB 1211-2 of the first pair 1216-1 of two opposite PCBs 1211-1, 1211-2. Therefore, the RF signal from the first RF chain 1132-(1,1) will radiate with different beams in a different direction from both planar antenna segments 1214-(1,1), 1214-(2,1) of the first MSMP antenna 1110-1. Note that the two antenna feeds 534H, 534V can be selected such that they radiate the same signal with different or same polarization. However, to avoid creating a phased array from the planar antenna segments 1214-(1,1), 1214-(2,1) with potential undesirable nulls in the desired coverage area, particularly in a setting where phase control and spacing between the segments cannot easily be accurately controlled, the two antenna feeds 534H, 534V from opposite antenna segments can be selected to radiate the same signal with cross polarization.

A second RF chain 1132-(2,1) of the first radio 1130-1 is interconnected in a similar manner through the interface matrix 1520 to each of the two ports of the same first planar antenna segment 1214-(1,1) of same first MSMP antenna 1110-1 fabricated on same first PCB 1211-1 of same first pair 1216-1 of two opposite PCBs 1211-1, 1211-2 and of the same second planar antenna segment 1214-(2,1) of same first MSMP antenna 1110-1 fabricated on same second PCB 1211-2 of same first pair 1216-1 of two opposite PCBs 1211-1, 1211-2. However, the second RF chain 1132-(2,1) of first radio 1130-1 interconnects to different antenna feeds 534H, 534V than the antenna feeds 534H, 534V interconnected to the first RF chain 1132-(1,1) of first radio 1130-1. A third and fourth RF chains 1132-(3,1), 1132-(4,1) of the same first radio 1130-1 are interconnected through the interface matrix 1520 to the third and fourth planar antenna segments 1214-(3,1), 1214-(4,1) of same first MSMP antenna 1110-1 fabricated on the third and fourth PCBs 1211-3, 1211-4 of the second pair 1216-2 of two opposite PCBs 1211-3, 1211-4 in a similar manner as the first and second RF chains 1132-(1,1), 1132-(2,1) are interconnected to the first and second planar antenna segments 1214-(1,1), 1214-(2,1) of the first MSMP antenna 1110-1 fabricated on the first and second PCBs 1211-1, 1211-2 of the first pair 1216-1 of two opposite PCBs 1211-1, 1211-2.

The interface matrix 1520 of the MR-MSMP antenna system 1500 can further include switching elements 1524 to dynamically and independently interconnect or disconnect each RF chain 1132-(k, i) of first radio 1130-1 to each of the antenna feeds 534H, 534V of the first MSMP antenna 1110-1. The state of the switching elements is configurable via the interface matrix control signals 1122. The interface matrix can also include inline RF filters 1526 to further reject signals outside the first radio 1130-1's operating frequency band.

The four RF chains 1132-(k,2) from the second radio 1130-2 are interconnected to the four planar antenna segments 1214-(j,2) of the second MSMP antenna 1110-2 in a similar manner as the four RF chains 1132-(k, 1) from the first radio 1130-1. For the second radio 1130-2, the interface matrix 1120 can further include switching elements 1524 to dynamically and independently interconnect or disconnect each RF chain 1132-(k,2) of the second radio 1130-2 to each of the antenna feeds 534H, 534V of second MSMP antenna 1110-2. The state of the switching elements 1524 is configurable via the interface matrix control signals 1122. The interface matrix 1520 can also include inline RF filters 1526 to further reject signals outside the operating band of the second radio. The interface matrix 1520 then enables the independent reconfiguration of the first radio 1130-1 and second radio 1130-2 coverage areas, including its profile, direction and width. For example, and without limitations, the coverage areas of the first radio 1130-1 and second radio 1130-2 could be configured in one instance to be substantially similar and in another instance to be mostly non-overlapping.

Referring now to FIGS. 13-14, the MR-MSMP antenna structure 1240 can include more or fewer PCBs 1211 and/or additional planar antenna segments 1214 per PCB. Furthermore, the reference plane between the PCBs 1211 can also be utilized to integrate other antennas 1110 for additional radios 1130. Referring now to FIG. 15, the MR-MSMP antenna system 1500 can be coupled with the same or a greater number of radios 1130 with same or greater number of RF chains. For example, and without limitations, two radios-like the eight RF chain radio to which the MSMP antenna system 900, 1000 communicates-could be used such that two radios with eight RF chains each is coupled with the MR-MSMP antenna system 1500.

One can appreciate that with the MR-MSMP antenna system 1100, 1500, the following benefits and features can be accomplished: (1) it is possible to independently achieve various coverage for each radio varying from an approximately 90×90 degree sector coverage to 160×160 degree sector coverage by selectively interconnecting the RF chains to the antenna feeds in the interface matrix 1120, 1520; (2) the coverage of each radio can be independently configure and can range from fully-overlapping to non-overlapping; (3) the achievable radiation patterns of each radio 1130-i have maximum gain in front of the MR-WND 1101 (along the Z axis) and minimize the signal propagation of signal close or beyond the reference plane (XY plane). This minimizes, as intended, the generated interference to adjacent wireless network devices and client devices using the same channel; (4) everywhere in the coverage area of each radio 1130-i, there is always two signals emanating on different beams with orthogonal polarization. This is a desired feature to provide efficient MIMO communication links with two spatial streams; (5) different RF signals of each radio 1130-i are radiated in different directions (e.g., the RF signals from the first and second RF chains 1132-(1,i), 1132-(2,i) radiate in substantially different directions as the RF signals from the third and fourth RF chains 1132-(3,i), 1132-(4,i)). This provides additional signal discrimination that further enhance the performance of MU-MIMO communications; (6) the antenna system 1100, 1500 provides several means to isolate the radios 1130-i (signal rejection antenna tuning, directionality, geometric arrangement, RF filtering) to enable concurrent multi-radio operation; and (7) the antenna system for the multiple radios 1130-i has a low profile and can be integrated in a wireless network device 1101 with an aesthetic design and form factor that is low profile. For instance, the MR-MSMP antenna structure 1240 that includes two MSMP antennas 1110-1, 1110-2, as shown in FIGS. 12 and 13, has an approximate length of 20 cm, width of 20 cm, and height of 1.6 cm when designed for two radios 1130-1, 1130-2 operating in the 5 GHz unlicensed band. One can thus appreciate the multiple significant and unique benefits provided by the disclosed MR-MSMP antenna system 1100, 1500 over state-of-the-art systems.

The MR-MSMP antenna system 1100, 1500 efficiently resolves the problem of providing efficient MIMO and MU-MIMO communications in UHD environments where wide type-1 coverage area is required and enable dynamic coverage and interference management.

One can appreciate that in combination the disclosed multi-radio multi-segment multi-port antenna system achieve all desired and optional features for a MR-WND antenna system in UHD environments. The disclosed antenna systems therefore provide great benefits over state-of-the-art systems for the design and operation of high capacity multi service wireless networks in UHD environments.

In general, innovative aspects of the technologies described herein can be implemented in wireless-access points that include one or more of the following aspects:

In general aspect 1, a wireless-access point comprises a first radio comprising at least two first radio-chain circuitry each configured to transmit respective radio frequency (RF) signals in a first channel; a second radio comprising at least two second radio-chain circuitry each configured to transmit, simultaneously to transmissions of the RF signals by the first radio, respective RF signals in a second channel which is non-overlapping with the first channel; and a plurality of planar antennas coupled with corresponding first radio-chain circuitry and second radio-chain circuitry to receive the RF signals. A first planar antenna is coupled with a first radio-chain circuitry of the first radio to receive therefrom a first RF signal in the first channel, the first planar antenna being arranged with its normal along a first direction, and configured to radiate the first RF signal along the first direction. A second planar antenna is coupled with a second radio-chain circuitry of the first radio to receive therefrom a second RF signal in the first channel, the second planar antenna being arranged with its normal along a second direction different from the first direction, and configured to radiate the second RF signal along the second direction. And, a third planar antenna is coupled with a third radio-chain circuitry of the second radio to receive therefrom a third RF signal in the second channel, the third planar antenna being arranged with its normal along a third direction, and configured to radiate the third RF signal along the third direction.

Aspect 2 according to aspect 1, wherein the normal of the third planar antenna is parallel to the normal of the first planar antenna.

Aspect 3 according to aspect 1 or 2, wherein the wireless-access point comprises a printed circuit board (PCB), wherein both the first planar antenna and the third planar antenna are printed on the PCB.

Aspect 4 according to any one of aspects 1 to 3, wherein each of the first planar antenna, the second planar antenna and the third planar antenna comprises a microstrip patch antenna.

Aspect 5 according to any one of aspects 1 to 3, wherein the first planar antenna comprises a first dual linear polarization microstrip patch antenna having a first feed and a second feed, the first feed coupled with the first radio-chain circuitry of the first radio to receive therefrom the first RF signal, and the second feed coupled with a fourth radio-chain circuitry of the first radio to receive therefrom a fourth RF signal, the first dual linear polarization microstrip patch antenna being configured to simultaneously radiate, along the first direction, the first RF signal and the fourth RF signal as a first pair of mutually orthogonally polarized beams; the second planar antenna comprises a second dual linear polarization microstrip patch antenna having a third feed and a fourth feed, the third feed coupled with the second radio-chain circuitry of the first radio to receive therefrom the second RF signal, and the fourth feed coupled with a fifth radio-chain circuitry of the first radio to receive therefrom a fifth RF signal, the second dual linear polarization microstrip patch antenna being configured to simultaneously radiate, along the second direction, the second RF signal and the fifth RF signal as a second pair of mutually orthogonally polarized beams; and the third planar antenna comprises a third dual linear polarization microstrip patch antenna having a fifth feed and a sixth feed, the fifth feed coupled with the third radio-chain circuitry of the second radio to receive therefrom the third RF signal, and the sixth feed coupled with a sixth radio-chain circuitry of the second radio to receive therefrom a sixth RF signal, the third dual linear polarization microstrip patch antenna being configured to simultaneously radiate, along the third direction, the third RF signal and the sixth RF signal as a third pair of mutually orthogonally polarized beams.

Aspect 6 according to aspect 5, wherein the normal of the third dual linear polarization microstrip patch antenna is parallel to the normal of the first dual linear polarization microstrip patch antenna.

Aspect 7 according to aspect 6, wherein the third dual linear polarization microstrip patch antenna is rotated relative to the first dual linear polarization microstrip patch antenna by an acute angle, such that a polarization of one of the third pair of mutually orthogonally polarized beams radiated by the third antenna is tilted by the acute angle relative to a polarization of a corresponding one of the first pair of mutually orthogonally polarized beams radiated by the first antenna.

Aspect 8 according to any one of aspects 1 to 7, wherein the wireless-access point comprises interface matrix circuitry coupled between the plurality of planar antennas and the at least two first radio-chain circuitry of the first radio, and the at least two second radio-chain circuitry of the second radio. Here, the interface matrix circuitry is configured to selectively transmit an RF signal from any one of the at least two first radio-chain circuitry of the first radio to none, one or multiple ones of the plurality of planar antennas, and selectively transmit, independently of the transmissions of RF signals by the first radio, an RF signal from any one of the at least two second radio-chain circuitry of the second radio to none, one or multiple ones of the plurality of planar antennas.

Aspect 9 according to any one of aspects 1 to 8, wherein the first antenna has a first reflection coefficient configured such that a first value of the first reflection coefficient at RF frequencies of the first channel is smaller by a first predetermined factor than a second value of the first reflection coefficient at RF frequencies of the second channel; and the third antenna has a third reflection coefficient, such that a first value of the third reflection coefficient at RF frequencies of the second channel is smaller by a second predetermined factor than a second value of the second reflection coefficient at RF frequencies of the first channel.

Aspect 10 according to aspect 9, wherein each of the first predetermined factor and the second predetermined factor is between 2 and 10, and each of the second value of the first reflection coefficient and the second value of the second reflection coefficient is between 0.85 and 0.99.

Aspect 11 according to aspect 9, wherein the first predetermined factor is the same as the second predetermined factor.

Aspect 12 according to any one of aspects 1 to 11, wherein the first channel belongs to a first operating frequency band, the second channel belongs to a second operating frequency band, and the first operating frequency band and second operating frequency band are in the 5 GHz unlicensed bands.

Aspect 13 according to any one of aspects 1 to 12, wherein the wireless access point comprises first RF filter circuitry coupled between the two or more first radio-chain circuitry of the first radio and the plurality of planar antennas, wherein the first RF filter circuitry are configured to reject RF signals at the RF frequencies of the second channel of the second radio; and second RF filter circuitry coupled between the two or more second radio-chain circuitry of the second radio and the plurality of planar antennas, wherein the second RF filter circuitry are configured to reject RF signals at the RF frequencies of the first channel of the first radio.

In general aspect 14, a wireless-access point comprises a first radio comprising first radio-chain circuitry configured to transmit a first radio frequency (RF) signal in a first channel; a second radio comprising second radio-chain circuitry configured to transmit, simultaneously to transmissions of the first RF signal by the first radio, a second RF signal in a second channel which is non-overlapping with the first channel; a first antenna coupled to the first radio-chain circuitry of the first radio to radiate the first RF signal, wherein the first antenna has a first reflection coefficient configured such that a first value of the first reflection coefficient at RF frequencies of the first channel is smaller by a first predetermined factor than a second value of the reflection coefficient at RF frequencies of the second channel; and a second antenna coupled to the second radio-chain circuitry of the second radio to radiate the second RF signal, wherein the second antenna has a second reflection coefficient configured such that a first value of the second reflection coefficient at RF frequencies of the second channel is smaller by a second predetermined factor than a second value of the second reflection coefficient at RF frequencies of the first channel.

Aspect 15 according to aspect 14, wherein the first channel belongs to a first operating frequency band, and the second channel belongs to a second operating frequency band that is adjacent to the first operating frequency band.

Aspect 16 according to aspect 14, wherein the first channel belongs to a first operating frequency band, the second channel belongs to a second operating frequency band, and the first operating frequency band and second operating frequency band are in the 5 GHz unlicensed bands.

Aspect 17 according to any one of aspects 14 to 16, wherein the first antenna comprises a first planar antenna formed on a first printed circuit board (PCB), and the second antenna comprises a second planar antenna formed on a second PCB different from the first PCB.

Aspect 18 according to any one of aspects 14 to 16, wherein the first antenna comprises a first planar antenna formed on a printed circuit board (PCB), and the second antenna comprises a second planar antenna formed on the same PCB as the first planar antenna.

Aspect 19 according to any one of aspects 14 to 18, wherein the first antenna comprises a first microstrip patch antenna having a first width and a first length configured to cause the first value of the first reflection coefficient at RF frequencies of the first channel to be smaller by the first predetermined factor than the second value of the first reflection coefficient at RF frequencies of the second channel, and the second antenna comprises a second microstrip patch antenna having a second width and a second length configured to cause the first value of the second reflection coefficient at RF frequencies of the second channel to be smaller by the second predetermined factor than the second value of the second reflection coefficient at RF frequencies of the first channel.

Aspect 20 according to aspect 19, wherein the first radio comprises third radio-chain circuitry configured to transmit, simultaneously to transmissions of the first RF signal by the first radio and the second RF signal by the second radio, a third RF signal in the first channel; the second radio comprises fourth radio-chain circuitry configured to transmit, simultaneously to transmissions of the first RF signal and the third RF signal by the first radio and the second RF signal by the second radio, a fourth RF signal in the second channel; the first microstrip patch antenna comprises a first dual linear polarization microstrip patch antenna having a first feed and a second feed, the first feed being coupled with the first radio-chain circuitry to receive the first RF signal therefrom and the second feed being coupled with the third radio-chain circuitry to receive the third RF signal therefrom, the first microstrip patch antenna configured to simultaneously radiate the first RF signal as a first beam having a first polarization and the third RF signal as a third beam having a third polarization orthogonal to the first polarization; and the second microstrip patch antenna comprises a second dual linear polarization microstrip patch antenna having a third feed and a fourth feed, the third feed being coupled with the second radio-chain circuitry to receive the second RF signal therefrom and the fourth feed being coupled with the fourth radio-chain circuitry to receive the fourth RF signal therefrom, the second microstrip patch antenna configured to simultaneously radiate the second RF signal as a second beam having a second polarization and the fourth RF signal as a fourth beam having a fourth polarization orthogonal to the second polarization.

Aspect 21 according to any one of aspects 14 to 20, wherein wireless-access point comprises a plurality of instances of the first antenna, each of the instances of the first antenna being coupled to the first radio-chain circuitry of the first radio; and a plurality of instances of the second antenna, each of the instances of the second antenna being coupled to the second radio-chain circuitry of the second radio.

Aspect 22 according to aspect 21, wherein the instances of the first antenna are arranged as a first array, and the instances of the second antenna are arranged as a second array, and at least one of the first array or the second array is a linear array.

Aspect 23 according to aspect 21, wherein the instances of the first antenna are spaced apart by between 0.4 to 0.6 of a first wavelength corresponding to the first channel, and the instances of the second antenna are separated by between 0.4 to 0.6 of a second wavelength corresponding to the second channel.

Aspect 24 according to aspect 21, wherein the wireless-access point comprises an enclosure arranged and configured to encompass the plurality of instances of the first antenna and the plurality of instances of the second antenna.

Aspect 25 according to any one of aspects 14 to 24, wherein each of the first predetermined factor and the second predetermined factor is between 2 and 10.

Aspect 26 according to aspect 25, wherein each of the first predetermined factor and the second predetermined factor is between 2 and 3; and each of the second value of the first reflection coefficient and the second value of the second reflection coefficient is between 0.85 and 0.99.

Aspect 27 according to any one of aspects 14 to 26, wherein the first predetermined factor is the same as the second predetermined factor.

Aspect 28 according to any one of aspects 14 to 27, wherein the wireless access point comprises a first RF filter coupled between first radio-chain circuitry of the first radio and the first antenna, wherein the first RF filter is configured to reject RF signals at the RF frequencies of the second channel of the second radio; and a second RF filter coupled between second radio-chain circuitry of the second radio and the second antenna, wherein the second RF filter is configured to reject RF signals at the RF frequencies of the first channel of the first radio.

In general aspect 29, a wireless-access point comprises a radio comprising at least two radio-chain circuitry each configured to transmit respective radio frequency (RF) signals; and at least two planar antennas coupled with corresponding radio-chain circuitry to receive the RF signals. A first planar antenna is coupled with a first radio-chain circuitry to receive therefrom a first RF signal, the first planar antenna being arranged with its normal along a first direction, and configured to radiate the first RF signal along the first direction. And, a second planar antenna is coupled with a second radio-chain circuitry to receive therefrom a second RF signal, the second planar antenna being arranged with its normal along a second direction different from the first direction, and configured to radiate the second RF signal along the second direction.

Aspect 30 according to aspect 29, wherein the first planar antenna comprises a first microstrip patch antenna, and the second planar antenna comprises a second microstrip patch antenna.

Aspect 31 according to aspect 29 or 30, wherein the first planar antenna comprises a first dual linear polarization microstrip patch antenna having a first feed and a second feed, the first feed coupled with the first radio-chain circuitry to receive therefrom the first RF signal, and the second feed coupled with a third radio-chain circuitry to receive therefrom a third RF signal, the first dual linear polarization microstrip patch antenna being configured to simultaneously radiate, along the first direction, the first RF signal and the third RF signal as a first pair of mutually orthogonally polarized beams; and the second planar antenna comprises a second dual linear polarization microstrip patch antenna having a third feed and a fourth feed, the third feed coupled with the second radio-chain circuitry to receive therefrom the second RF signal, and the fourth feed coupled with a fourth radio-chain circuitry to receive therefrom a fourth RF signal, the second dual linear polarization microstrip patch antenna being configured to simultaneously radiate, along the second direction, the second RF signal and the fourth RF signal as a second pair of mutually orthogonally polarized beams.

Aspect 32 according to aspect 31, wherein a third dual linear polarization microstrip patch antenna has a fifth feed and a sixth feed, the fifth feed coupled with a fifth radio-chain circuitry to receive therefrom a fifth RF signal, and the sixth feed coupled with a sixth radio-chain circuitry to receive therefrom a sixth RF signal, the third dual linear polarization microstrip patch antenna being arranged with its normal along a third direction different from each of the first direction and the second direction, and configured to simultaneously radiate, along the third direction, the fifth RF signal and the sixth RF signal as a third pair of mutually orthogonally polarized beams; and a fourth dual linear polarization microstrip patch antenna has a seventh feed and an eight feed, the seventh feed coupled with a seventh radio-chain circuitry to receive therefrom a seventh RF signal, and the eight feed coupled with an eight radio-chain circuitry to receive therefrom an eight RF signal, the fourth dual linear polarization microstrip patch antenna being arranged with its normal along a fourth direction different from each of the first direction, the second direction and the third direction, and configured to simultaneously radiate, along the fourth direction, the seventh RF signal and the eight RF signal as a fourth pair of mutually orthogonally polarized beams.

Aspect 33 according to any one of aspects 29 to 32, wherein the second RF signal is another instance of the first signal, and both the first planar antenna and the second planar antenna are coupled with the first radio-chain circuitry to receive therefrom the first RF signal.

Aspect 34 according to any one of aspects 29 to 33, wherein the wireless-access point comprises interface matrix circuitry coupled between the at least two planar antennas and the at least two radio-chain circuitry, the interface matrix circuitry configured to selectively transmit an RF signal from any one of the at least two radio-chain circuitry to none, one or multiple ones of the at least two planar antennas.

In some implementations, the foregoing antenna system can be used to efficiently implement the multi-segment multi-port antenna system and multi-radio multi-segment multi-port antenna system for the WNDs and MR-WNDs, respectively.

In particular, details of a compact integral conformal antenna system for a MR-WND, such as an access point or base station, comprising multiple MIMO and/or MU-MIMO capable radios, are described. This compact integral conformal antenna system is such that the multiple MIMO and/or MU-MIMO capable radios can operate concurrently within a defined frequency band or bands, and thus enable the MR-WND to send and receive multiple independent, but concurrent, RF signal streams with sufficiently high fidelity to enable high bandwidth connectivity to large numbers of client devices.

The multi segment multi-port antenna systems and multi radio multi segment multi-port antenna systems illustrated in FIGS. 6-15 have several deficiencies. First, they require RF coaxial cables as means to couple RF signals from the interface matrix on one PCB to antenna feeds on another PCB. RF coaxial cables and connectors have major drawbacks. They are inherently lossy and prone to manufacturing assembly error. In addition, the number of RF coaxial cables grows quickly with multiple radios having multiple RF chains. Second, the metal support where the antenna system is mounted has a predefined bent angle (preferably 30 degree) to create a pre-determined coverage. Finally, the above-noted antenna systems require the precise assembly of multiple separate PCB's, which is a lengthy and error prone process.

The objective of the present disclosure is to show particular methods to implement and fabricate a compact integral conformal antenna with the following features and aspects that are important to construct a low-profile and compact MR-WND.

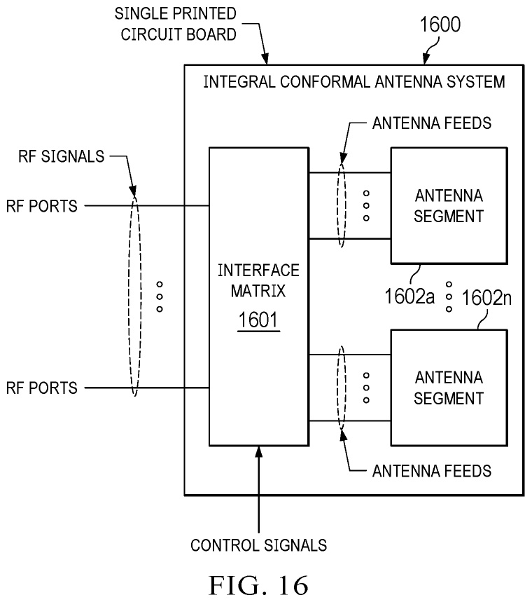

As illustrated in FIG. 16, an integral conformal antenna system comprises an interface matrix 1601 and at least two antenna segments 1602a . . . 1602n. The interface matrix 1601 and the antenna segments 1602a . . . 1602n are fabricated on a single printed circuit board (PCB). Each antenna segment has one or more antenna feeds. The interface matrix 1601 comprises multiple RF ports and provides means to distribute the RF signals from the RF ports to the antenna feeds of the antenna segments 1602a . . . 1602n.

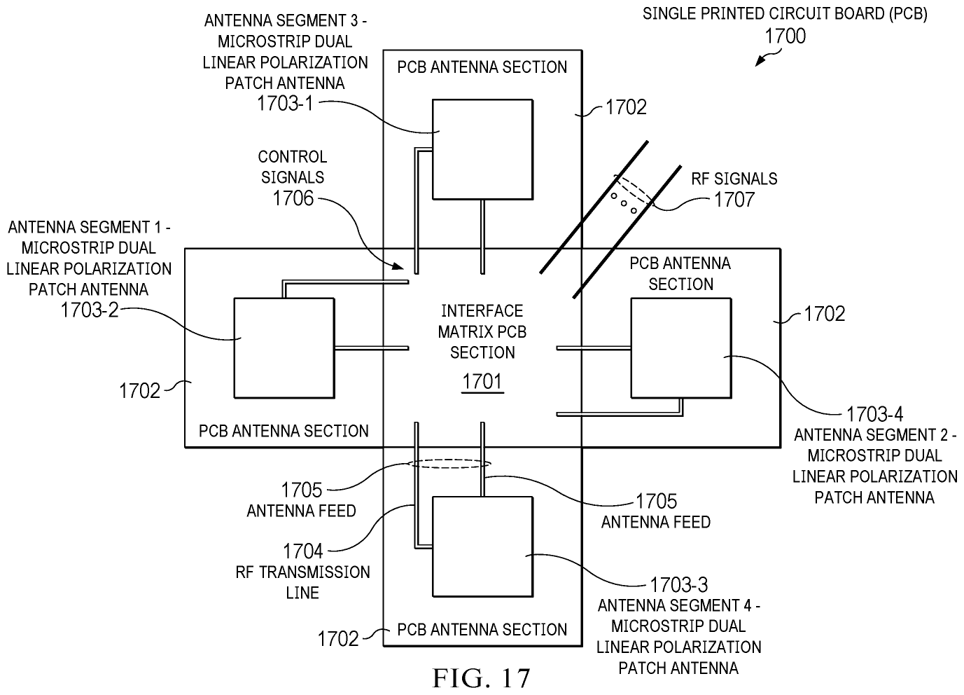

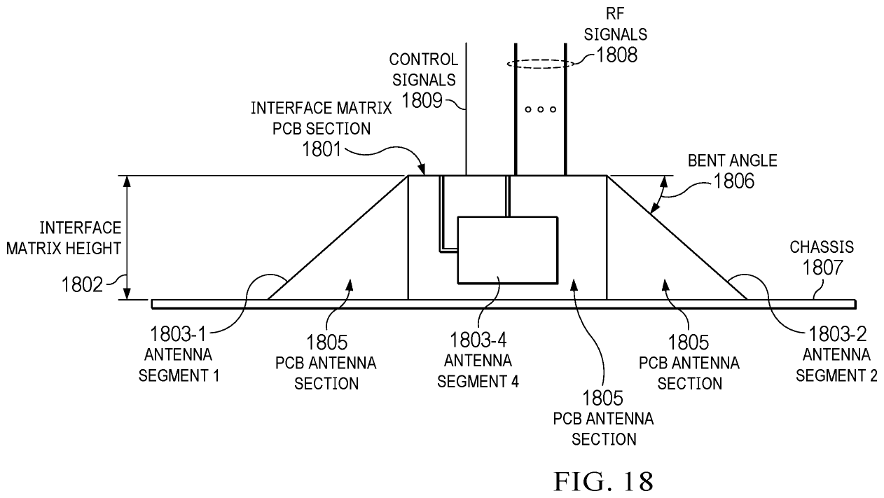

For illustrative purpose, and without limitations, FIGS. 17 and 18 show the top view and side view, respectively, of an integral conformal antenna system comprising four antenna segments 1703 (1803). The multiple antenna segments 1703 (1803) are of the printed planar type such as, but not limited to, microstrip patch, inverted F, dipole, etc. In FIGS. 17 and 18, each antenna segment 1703 (1803) includes a micro strip dual linear polarization patch antenna with two antenna feeds. The integral conformal antenna system comprises at least two PCB antenna sections 1702 (1805) and an interface matrix PCB section 1701 (1801). The antenna segments 1703 (1803) are printed on the PCB antenna sections 1702 (1805) and each PCB antenna section 1702 (1805) comprises one or more antenna segments 1703 (1803).

The different PCB antenna sections 1702 (1805) and the interface matrix PCB section 1701 (1802) are all mutually disjoint (non-overlapping) but are all part of a single integral printed circuit board 1700 with at least one common substrate layer. At least one substrate layer of the PCB stack, used to fabricate the integral conformal antenna system, is common to all PCB antenna sections 1702 (1805) and the interface matrix PCB section 1701 (1801) and enables the coupling of RF signals 1707 (1808) between the interface matrix PCB section 1701 (1801) and the different PCB antenna sections 1702 (1805) using RF transmission lines 1704.

The PCB antenna sections 1702 (1805) of the compact integral conformal antenna system can also be bent (folded) at a given bent angle 1806 with respect to the interface matrix PCB section 1701 (1801) to form a conformal structure. This unique feature is used to provide a flexible antenna ranging from a planar structure (PCB antenna sections bent angle=0 degree) to a conformal structure (PCB antenna sections bent angle larger than 0 degree but less than 90 degree). For antenna segments 1703 (1803) radiating RF signals 1707 (1808) according to a directional radiation pattern, different bent angles 1806 for the PCB antenna section 1702 (1805) provide a way to orient the radiation pattern in different directions and thereby provide different coverage area for the RF signals.

The RF signals 1707 (1808) from the RF ports are coupled to the interface matrix. The interface matrix provide means, such as, but not limited, RF transmission lines 1704, RF switches, RF filters, power dividers, power combiners, etc. to couple the RF signals 1707 (1808) from the RF ports to none, one, or multiple of the antenna segment antenna feeds 1705. Optionally, the coupling can be dynamically determined using the control signals 1706 (1809). The interface matrix may also include RF connectors to enable the coupling of the RF signals from the RF chains using cables.

In most embodiments, the interface matrix is implemented on the interface matrix PCB section 1701 (1801). However, in some embodiments, part or all of the interface matrix are implemented on the PCB antenna sections 1702 (1805). For example, and without limitations, an interface matrix permanently coupling each RF ports to one antenna feed 1705 can be implemented using RF connectors directly on the appropriate PCB antenna section 1702 (1805). In some embodiments, where there are only two PCB antenna sections 1702 (1805), the interface matrix PCB section 1701 (1801) might have a null area. In the following, and without loss of generality, we assume that the interface matrix is entirely implemented on the interface matrix PCB section 1701 (1801).

The PCB 1700 used to implement the multi-port integral conformal antenna system interface may also host other components such as printed antennas, chip antennas, memories, processor, radios, RF integrated circuits, etc.

As shown in FIG. 18, each of the PCB antenna section 1805, and by extension the antenna segments printed on the PCB antenna section 1805, can be bent at a given bent angle 1806 between 0 and 90 degrees. Anyone skilled in the art would appreciate that the interface matrix PCB section height 1802 from a chassis 1807 determine the four (4) PCB antenna sections (and antenna segments) bent angles 1806. By varying the height of the interface matrix PCB section 1801 and fixing the bottom of the PCB antenna section 1805 to the chassis 1807, bent angles 1806 from zero (0) to ninety (90) degree are achieved.

In a particular embodiment, the printed circuit board (PCB) 1700 has multi dielectric substrate and metal layers; where the top dielectric substrate is thick and suitable for antenna substrate. The bottom dielectric substrate is a thin composite material suitable for RF signal trace comprising woven fiberglass cloth with an epoxy resin binder. Example of such substrate for the bottom dielectric substrate include but is not limited to FR-4 or VT-47.

Furthermore, in this embodiment, the compact integral conformal antenna system can be bent to form a conformal structure by removing the top substrate at the junction between the PCB antenna sections 1702 (1805) and the interface matrix PCB section 1701 (1801). Someone who is expert in the art will appreciate this feature as a method to conveniently fabricate the integral conformal antenna system with conventional rigid substrates at lower cost than using flexible polymer film which results in a more expensive PCB.

In addition, it is desirable that the compact integral conformal antenna system radiates signals with orthogonal polarization and provides means to isolate signals transmitted on different channels to enable the simultaneous operation of multiple radios.

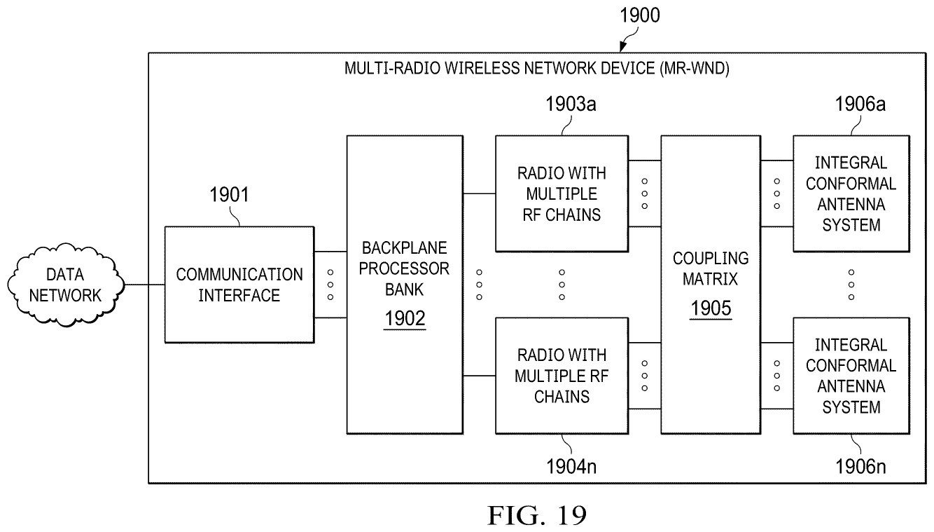

FIG. 19 shows a MR-WND 1900 comprising communication interface 1901 for communication with a data network, one or more integral conformal antenna systems 1906a . . . 1906n. The coupling matrix 1905 provides means to couple the RF signals transmitted from multiple RF chains of the multiple radios 1904a . . . 1904n to the ports of the integral conformal antenna systems 1906a . . . 1906n. An integral conformal antenna system can be coupled to RF signals transmitted from one or more radios, and different RF signals from a radio can be coupled to one or more integral conformal antenna systems.

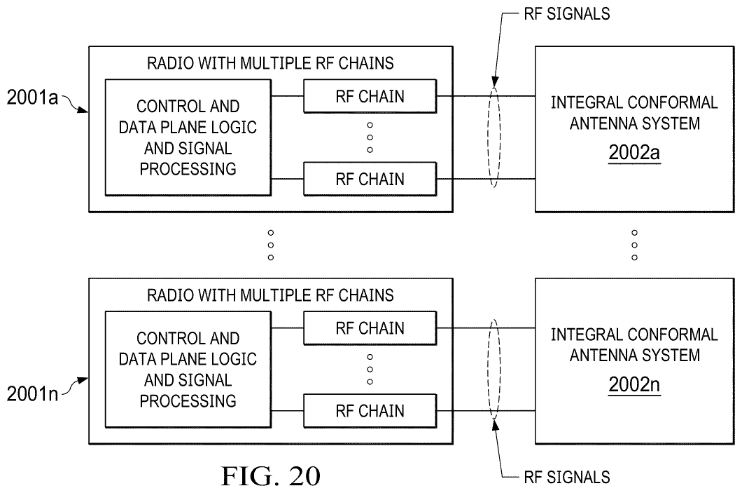

FIG. 20 shows an embodiment where each integral conformal antenna system 2002a-2002n is coupled to all RF signals from different radios 2001a . . . 2001n.

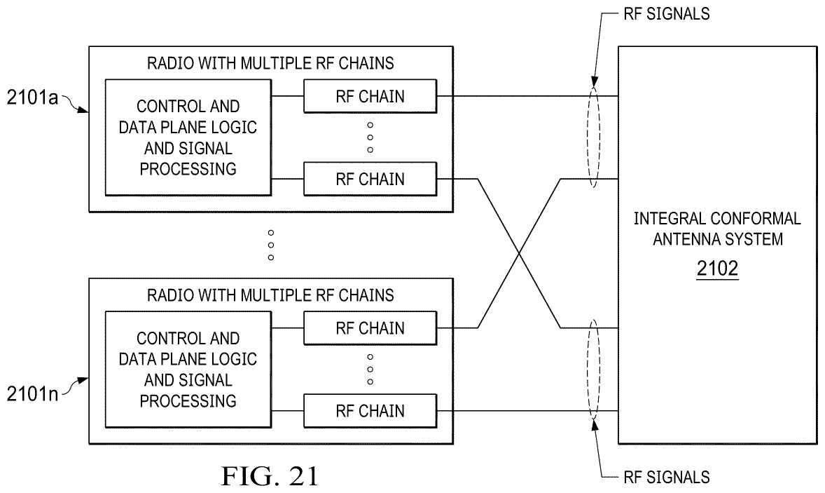

FIG. 21 shows an alternative embodiment where an integral conformal antenna system 2102 is coupled to all RF signals from multiple radios 2101a . . . 2101n.

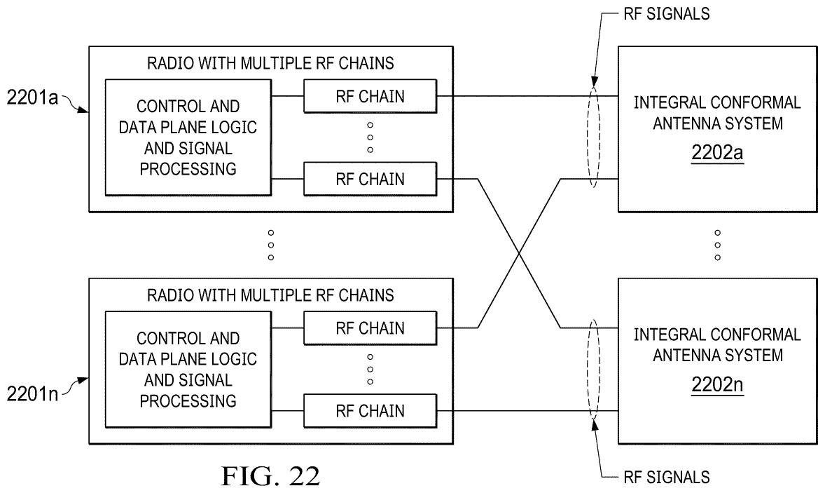

FIG. 22 shows an alternative embodiment where an integral conformal antenna system is coupled to RF signals from different radios, and the different RF signals from a radio are coupled to different integral conformal antenna systems. Other embodiments are also possible.

Various embodiments of the integral conformal antenna system and its integration in a wireless networks device are described next.

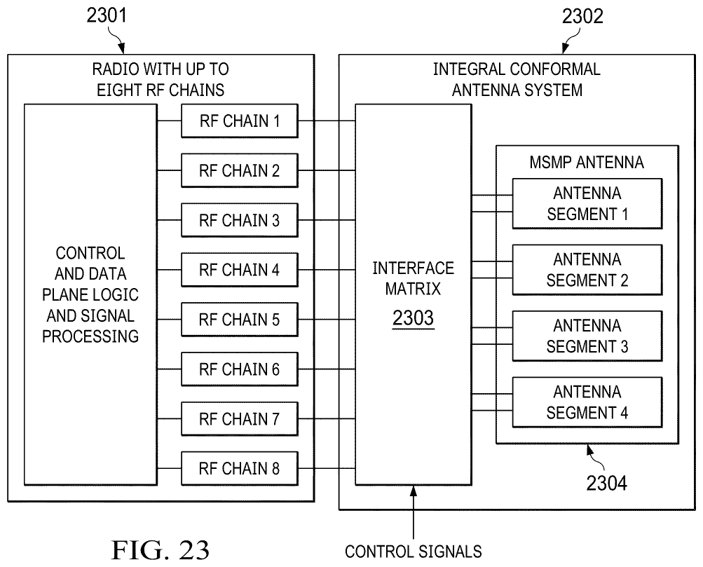

FIG. 23 shows a first embodiment of an integral conformal antenna system 2302 coupled with one radio 2301 having up to 8 RF chains. Skilled practitioners could extend this embodiment to include multiple radios (more than 1) with total RF chains from the multiple radios less than or equal to 8.

The MSMP antenna 2304 comprises four antenna segments. Each antenna segment has two (2) separated feeds, where each feed can be connected, through the interface matrix 2303, to an RF chain of the radio. Each RF chain transmits/receives a RF signal from the radio. Generally, an RF signal from an RF chain can be interconnected to none, one or more than one antenna feed and an antenna feed can be connected to none, one or more than one RF chain. The interconnection between the RF chain and the antenna feeds can be fixed or dynamically determined by the interface matrix control signals. RF signals coupled to the two different RF antenna feeds of a common antenna segment port are radiated by the antenna segment with two different directional (non-omnidirectional) beams. Both directional beams radiate the RF signals with substantially similar radiation patterns, but with orthogonal polarizations. We refer to these dual beams as the vertical polarization beam and horizontal polarization beam of the antenna segment port.

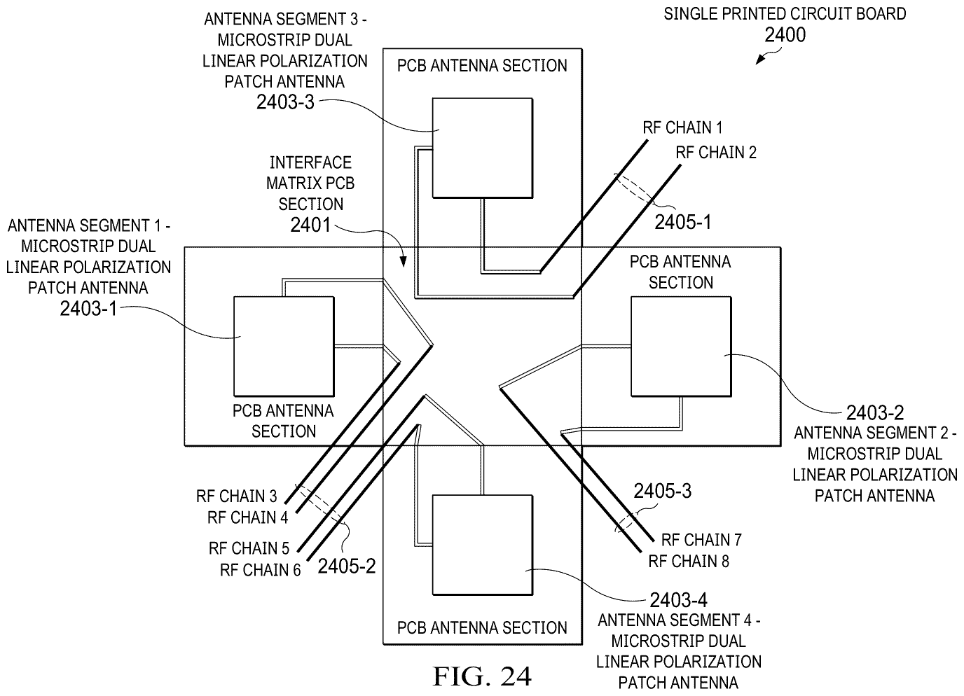

FIG. 24 illustrates one of several possible configurations of the interface matrix that interconnects the eight (8) antenna feed ports to eight (8) RF chains 2405. A single printed circuit board 2400 includes an interface matrix PCB section 2401, antenna segments 2403-1 through 2403-4. Each antenna segment 2403 can be a microstrip dual linear polarization patch antenna. In this embodiment, the interface matrix includes RF connectors and transmission lines between the RF connectors and the antenna feeds.

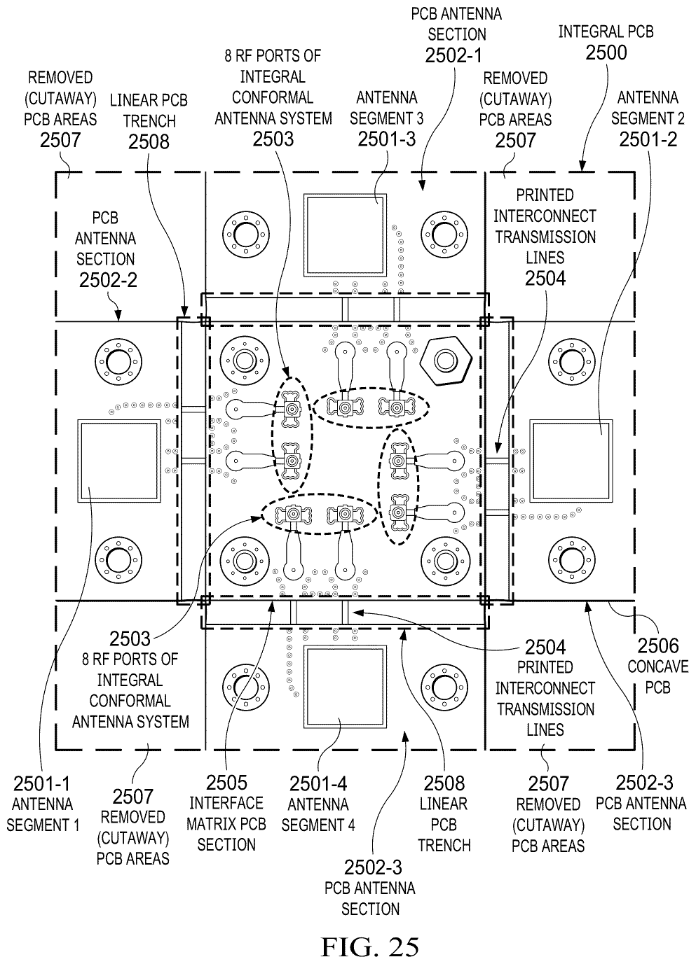

FIG. 25 shows the circuit layout of this integral conformal antenna system. Each of the four MSMP antenna segments 2501 is printed on a different PCB antenna section 2502. An integral PCB 2500 includes PCB antenna sections 2502, antenna segments 2501, RF ports 2503, printed interconnect transmission lines 2504, interface matrix PCB section 2505, concave PCB 2506, linear PCB trench 2508 and removed (cutaway) PCB areas 2507.

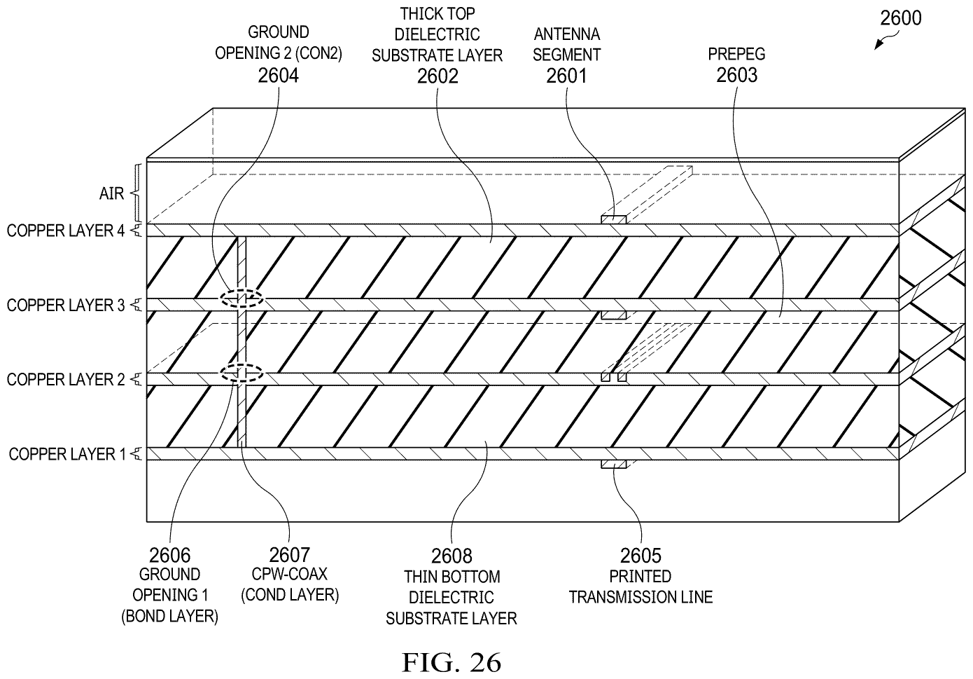

The integral conformal antenna system is fabricated using a multi-layer PCB with a minimum of two (2) dielectric substrates, i.e. the top substrate 2602 and the bottom substrate 2608, and a minimum of 4 metal layers (e.g., copper layers). As an example, a PCB stack up of such multi-layer PCB is illustrated in FIG. 26. The antenna segments 2501-1 to 2501-4 illustrated here are printed microstrip dual linear polarization patch antenna and fabricated on the top, thick rigid dielectric substrate 2602. The thick dielectric substrate 2602 will typically have a thickness above 10 mils (1 mil= 1/1000 inch) for antennas operating at frequencies below 6 GHz. The printed microstrip dual linear polarization patch antennas are printed on the top copper layer, layer 4. Also shown are CPW-coax 2607 and ground openings 2606, 2604. Prepeg 2603 is disposed between the copper layers.

A skilled practitioner will appreciate the use of thick dielectric substrate to enhance the performance of microstrip patch antennas. The choice of antennas is not limited to printed microstrip patch antenna in this disclosure. Other types of planar printed antenna such as planar inverted-F antenna, planar dipole can be used. Each printed patch antenna has two (2) antenna feeds, which are connected to the interface matrix implemented on the interface matrix PCB section through printed transmission lines.

The printed transmission lines are fabricated on the bottom, thin dielectric substrate. The transmission line RF signal and ground traces are printed on the bottom layer of the bottom substrate (layer 1). The thin dielectric substrate will typically have a thickness below 5 mils and comprises woven fiberglass cloth with an epoxy resin binder. An example of this type of substrate is FR-4. A skilled practitioner will appreciate the use of thin dielectric substrate for printed transmission line. The printed transmission lines between the PCB antenna section and the interface matrix PCB section eliminate the use of RF coaxial cables to connect the antenna segments and the interface matrix in the multi segment multi-port antenna systems and multi radio multi segment multi-port antenna systems illustrated in FIGS. 6-15.

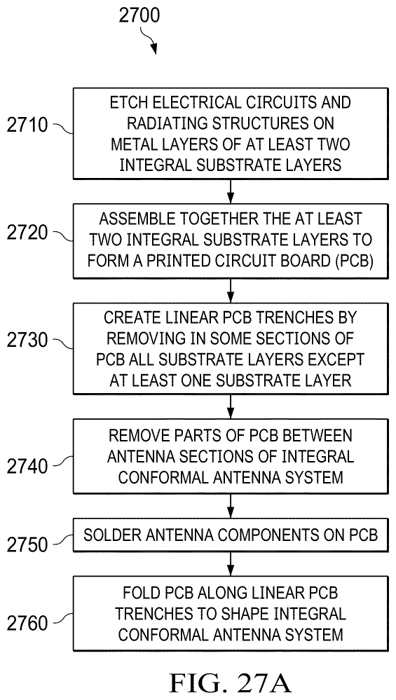

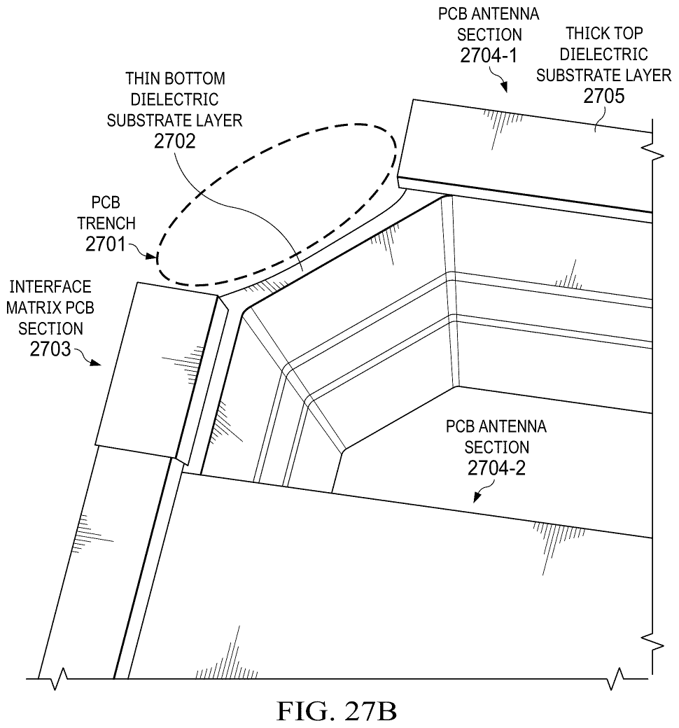

FIG. 27A shows a flow chart including the main steps of a process 2700 for fabricating an integral conformal antenna systems in accordance with the disclosed technologies. For example, the process 2700 can be used to fabricate the conformal antenna system described above in connection with FIGS. 24-26.

At 2710, the metal layers of each complete integral substrate layer is etched to print the desired circuits on both substrate side.

At 2720, the multiple integral substrate layers are assembled or glued together to form the entire PCB stack. If there are multiple integral conformal antenna systems printed on the same PCB, then the PCB is cut into multiple integral PCBs, each integral PCB comprising a single integral conformal antenna system. At this step, each integral conformal antenna system is an integral PCB with all substrate layers in the PCB stack.

At 2730, as shown in FIG. 27B, the top dielectric substrates of the PCB stack are removed on the four sides of the interface matrix PCB section between the PCB antenna sections and the interface matrix PCB section, thus creating four linear PCB trenches. In these trenches, the bottom thin dielectric substrate with interconnecting transmission lines printed on metal layer 4 and grounding plane printed on metal layer 3 remains. This procedure enables bending the PCB antenna sections, and by extension the antenna segments, at various bent angles, while maintaining a common substrate layer to the PCB antenna sections and the interface matrix PCB section enabling the coupling of RF signals between the various sections of the PCB.

At 2740, parts of the PCB are then removed (all layers are removed) between the PCB antenna sections of an integral conformal antenna system. Note that in some embodiments 2730 and 2740 can be performed in reverse order. After 2730 and 2740 were performed, the PCB comprising a single integral conformal antenna system is a concave shape. In some embodiments, part of the PCB can remain between the PCB antenna sections to preserve the PCB structure rigidity. During the last bending step, the remaining parts will be broken and removed.

At 2750, components, such as, but not limited to, RF connectors, RF filters, and RF switches, can be soldered on the PCB. This is an optional step since, in some embodiments of the disclosed antennas, the other end of RF cables connected to the radios are directly soldered on the PCB, and there are, thus, no components to be soldered at 2750.

At 2760, the PCB antenna sections are bent by folding the PCB structure along the linear PCB trenches. Because the bottom dielectric substrate 2702 is thin, it permits the PCB antenna sections 2704 hosting antenna segment 1, 2, 3 and 4 to be easily bent and form an arbitrary angle with respect to the interface matrix PCB section 2703. A bent angle of ninety (90) degree is illustrated in FIG. 27B. Note that the bent angle is defined as the angle between a PCB antenna section 2704 and the interface matrix PCB section 2703. The bent angle can be realized with a single fold along the linear PCB trenches 2701 or multiple folds or a curved fold. The use of a thick top dielectric substrate 2705 comprising woven fiberglass cloth with an epoxy resin binder enables the implementation of an integral conformal antenna system at a significantly lower cost than if flexible polymer film was used, as is usually the case for the realization of flexible PCB. Although a substrate comprising woven fiberglass cloth with an epoxy resin binder doesn't provide as much flexibility as flexible polymer film, the level of flexibility provided between 0 and 90 degrees bending is sufficient for integral conformal antenna system applications.

The interconnecting transmission line between the interface matrix PCB section and PCB antenna sections illustrated here is of the type coplanar waveguide with ground (CPWG), but other type such as microstrip transmission line, coplanar waveguide (CPW), substrate integrated waveguide (SIW) can also be used. The interface matrix of the integral conformal antenna system comprises 8 RF ports consisting of RF connectors soldered on the interface matrix PCB section and simply uses transmission lines between each of the 8 RF port on the interface matrix PCB section and the 8 antenna segment feeds on the 4 PCB antenna sections. In one embodiment the 8 RF ports are coupled to 8 different RF signals from a single radio. The fabrication process 2700 may include other steps.

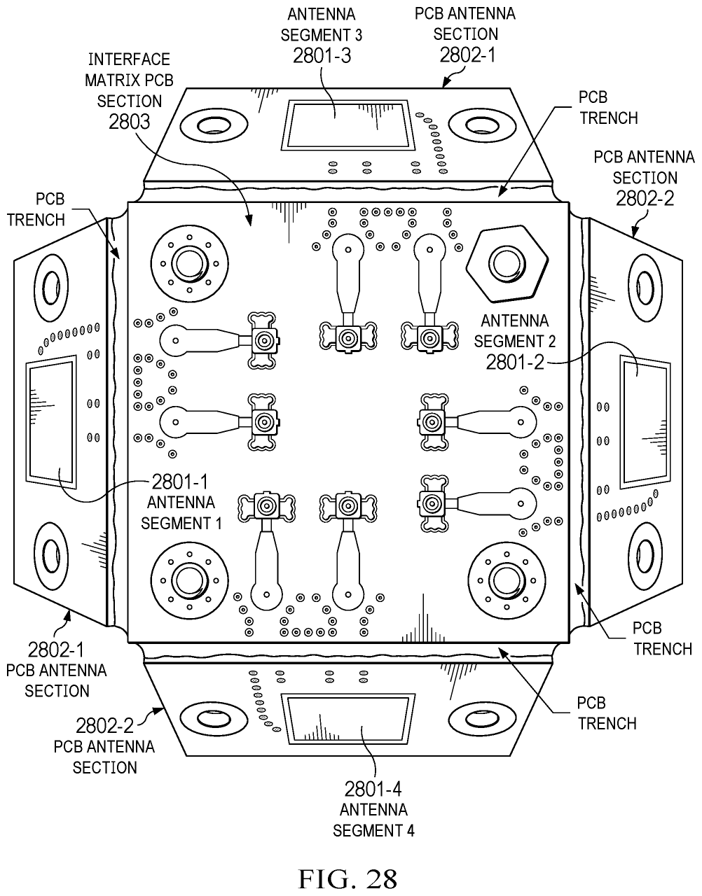

FIG. 28 is an image of an example of an integral conformal antenna system fabricated by using the process 2700. Note that an integral conformal antenna system fabricated by using the process 2700 can include additional components, including, but not limited to, radios, memories, processors, antennas, etc. Such additional components can be disposed on the same integral PCB of the integral conformal antenna system.

The disclosed integral conformal antenna system suitably provides various coverage area depending on the bend angles of the antenna segments 2801, which can be set by selecting an appropriate height between the interface matrix PCB section 2803 and the chassis. Moreover, different integral conformal antenna systems in a MR-WND can be independently bent at any arbitrary angles that can be the same or different for the different antenna systems. This feature is useful when the present flexible antenna system is used in a multi-radio wireless access point, where each radio can have different coverage area. Electrical means can also be used to electrically adjust the interface matrix PCB section 2803 height and dynamically change the coverage area dimension. In other configurations, it also possible to bend the different antenna segments 2801 of the same integral conformal antenna system at different angles. Also shown in FIG. 28 are PCB antenna sections 2802 and PCB trenches.

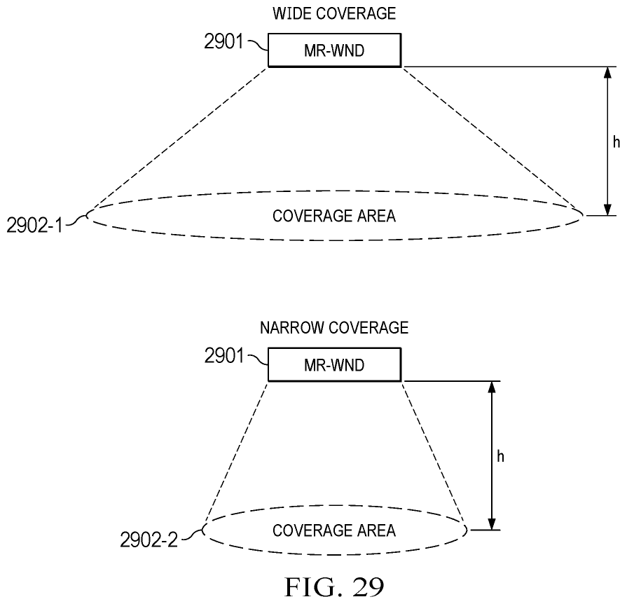

FIG. 29 illustrates two coverage scenarios from a ceiling-mounted MR-WND 2901, mounted at the same height for both scenarios. The ceiling-mounted MR-WND 2901 integrates an integral conformal antenna system. The first scenario has a wide coverage area 2902-1, while the second scenario has a narrow coverage area 2902-2. The wide coverage area 2902-1 of the first scenario is achieved by using a larger bent angle (higher interface matrix height) than in the second narrow coverage area 2902-2.

Two embodiments of integral conformal antenna systems and their use in a multi-radio wireless network device (MR-WND) are described below.

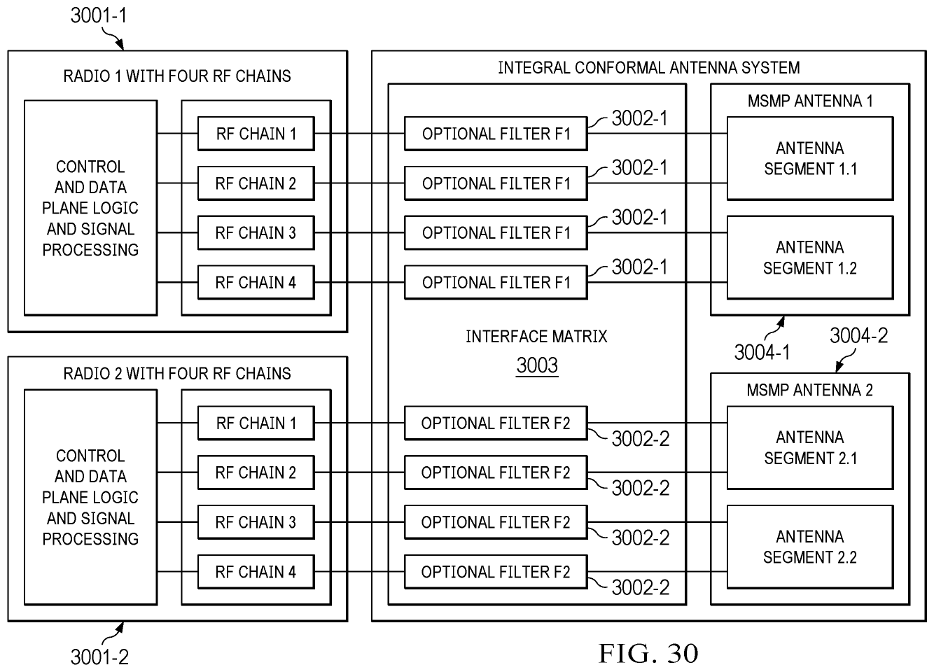

FIG. 30 illustrates another embodiment of the multi-port integral conformal antenna system and its interface to two radios 3001-1, 3001-2, each with 4 RF chains. Radio 3001-1 is transmitting RF signals in a radio channel belonging to Band #1 and Radio 3001-2 is transmitting RF signals in a radio channel belonging to Band #2. Band #1 and #2 are mostly non-overlapping frequency band. The integral conformal antenna system comprises two multi-segment multi-port (MSMP) antennas 3004-1, 3004-2. The first multi-segment multi-port 3004-1 (MSMP 1) comprises two antenna segments (antenna segments 1.1 and 1.2) and the second multi-segment multi-port 3004-2 (MSMP 2) comprises two antenna segments (antenna segments 2.1 and 2.2). All antenna segments comprise two antenna feeds. The four RF chains of the first radio are coupled to the four antenna feeds of the first MSMP antenna through an interface matrix 3003 and the four RF chains of the second radio are coupled to the four antenna feeds of the second MSMP antenna through the interface matrix 3003.

The MSMP 1 antenna segments 1.1 and 1.2 are designed to have low reflection coefficient in Band #1 and high reflection coefficient in Band #2. The MSMP 2 antenna segments 2.1 and 2.2 are designed to have high reflection coefficient in Band #1 and low reflection coefficient in Band #2. This design feature is to enhance the isolation of RF signals on different frequency bands. Band pass filters 3002 (F1 and F2 as shown in FIG. 30) can further be added in the interface matrix 3003 to achieve higher isolation, if needed, between the RF signals from the different radios 3001.

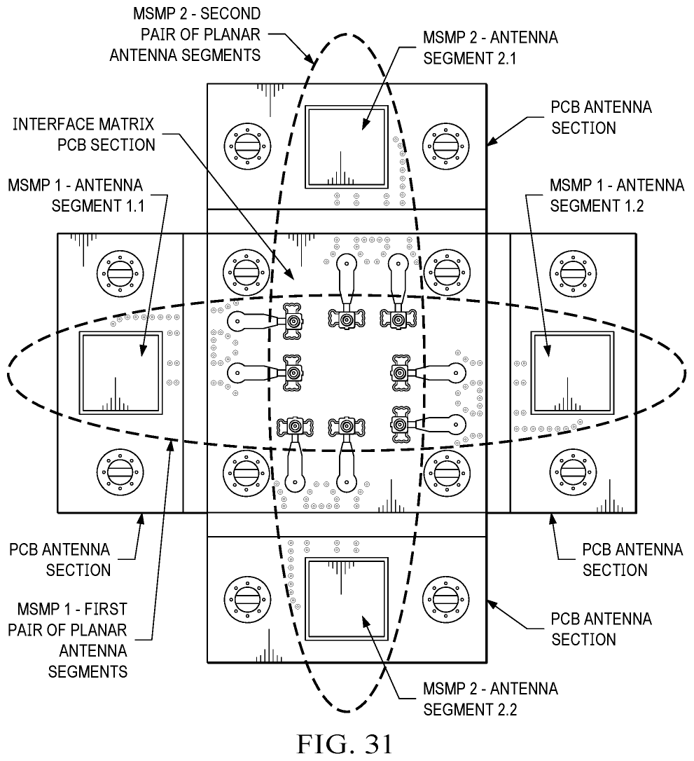

FIG. 31 shows an implementation of the integral conformal antenna system described in FIG. 30. The MSMP 1 and MSMP 2 antenna segments are printed microstrip dual linear polarization patch antenna. The pair of two antenna segments of MSMP 1 are positioned on 2 PCB antenna sections on opposite side of the interface matrix PCB section such that the 2 PCB antenna section normals (direction orthogonal to the PCB antenna section plane) for all bent angles lie in a first plane while the pair of two antenna segments of MSMP 2 are positioned on 2 PCB antenna sections on the other opposite side of the interface matrix such that the 2 PCB antenna section normals for all bent angles lie in a second plane orthogonal to the first plane. The width and length of MSMP 1 antenna segments 1.1 and 1.2 are tuned to achieve low reflection coefficient in Band #1, whereas the width and length MSMP 2 antenna segments 2.1 and 2.2 are tuned to achieve low reflection coefficient in Band #2. A skilled practitioner would appreciate the cost, size and performance advantages of this antenna structure to simultaneously support two MIMO radios each with 4 RF chains and enable their concurrent operation.

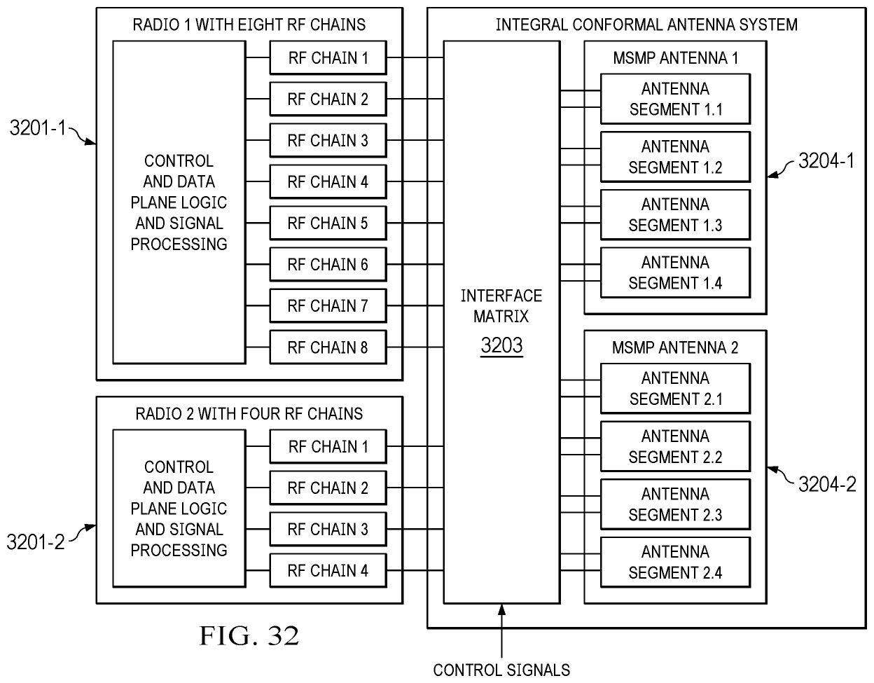

FIG. 32 illustrates another embodiment of the multi-port integral conformal antenna system and its interface to two radios 3201-1, 3201-2 where the first radio has up to 8 RF chains and the second radio has up to 4 RF chains. The first radio 3201-1 and the second radio 3201-2 are transmitting RF signals on channels belonging to non-overlapping frequency bands. The multi-port integral conformal antenna system comprises an interface matrix 3203 and two MSMP antennas 3204-1, 3204-2, each with four antenna segments. The four antenna segments 1.1 to 1.4 of the first MSMP antenna 3204-1 have two antenna feeds each and the four antenna segments 2.1 to 2.4 of the second MSMP antenna 3204-2 have one antenna feed each.

The up to eight RF chains of the first radio 3201-1 are coupled to the eight antenna feeds of the first MSMP antenna 3204-1 through the interface matrix 3203, and the up to four RF chains of the second radio 3201-2 are coupled to the four antenna feeds of the second MSMP antenna 3204-2 through the interface matrix 3203.

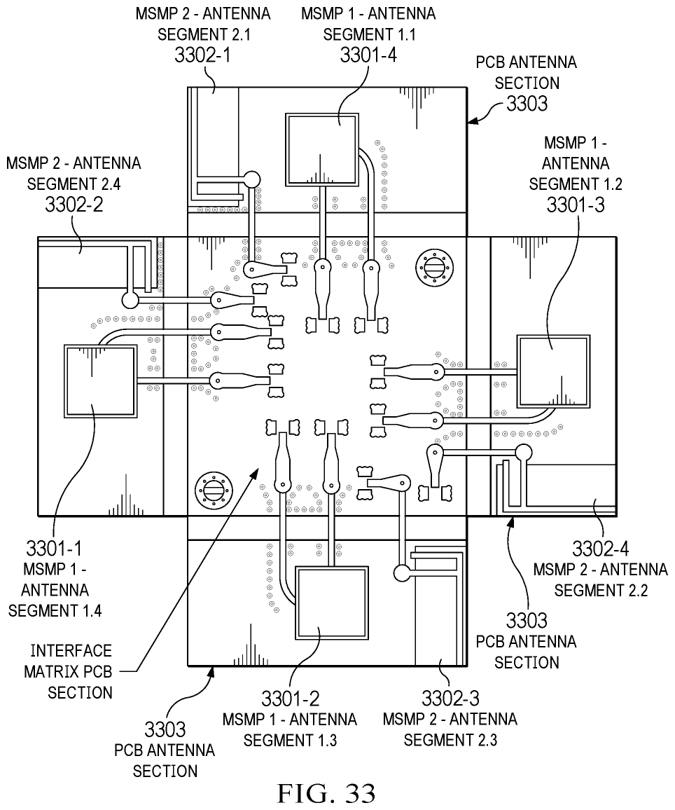

FIG. 33 shows an implementation of the multi-port integral conformal antenna system described in FIG. 32. The MSMP 1 antenna segments 3301 are printed microstrip dual linear polarization patch antenna and the MSMP 2 antenna segments 3302 are printed inverted-F. Each PCB antenna section 3303 comprises one MSMP 1 antenna segment 3301 and one MSMP 2 antenna segment 3302. It is understood that two inverted-F can also be printed on each PCB antenna section 3303 and enable the extension of the number of RF radio chains of second radio up to eight chains. Alternatively, the inverted-F antenna segments could be replaced by printed microstrip dual linear polarization patch antenna. Thus, two radios, each with up to 8 RF chains, can be connected to the disclosed multi-port integral conformal antenna system having a conformal and small footprint while still meeting the required isolation for concurrent operation.

The skilled practitioner would appreciate the advantages of the technologies disclose herein and could extend the disclosed technologies to other configurations such as, but without limitations, other number of radios, number of RF ports per radio, number of antennas per PCB antenna section, number of PCB antenna sections, type of printed antennas, interface matrix implementation, disposition of antenna sections on the edges of the interface matrix, interface matrix geometry, interconnection between the radios and multi-port antennas, etc. For example, and without limitations, the multi-port MSMP antennas illustrated in FIGS. 8, 9, 10, and 15 can all be implement using the disclosed multi-port integral conformal antenna system.

A number of embodiments of the invention have been described. Nevertheless, it will be understood that various modifications may be made without departing from the spirit and scope of the invention.

What is claimed is:

1. An antenna system comprising:
a planar printed circuit board (PCB) with two or more PCB sections;
a dielectric substrate layer common to at least two PCB sections;
a plurality of antennas or antenna elements printed on two or more PCB sections; means to couple radio frequency (RF) signals between at least two PCB sections using RF transmission lines;
means to interconnect antennas or antenna elements on one or more PCB sections to one or more radios; and
means to bend at least one PCB section relative to an adjacent PCB section in a range of angles from 0° to at least 90°.

2. The antenna system of claim 1, wherein the planar PCB is a multi-layer PCB with at least two dielectric substrates and at least four metal layers.

3. The antenna system of claim 2, wherein the PCB includes linear PCB trenches between two or more PCB sections.

4. The antenna system of claim 3, wherein the PCB trenches comprise a dielectric substrate with interconnecting transmission lines printed on a first metal layer and a grounding plane printed on a second metal layer to enable bending of adjacent PCB sections at a plurality of bend angles while maintaining RF signal transmission between adjacent PCB sections.

5. The antenna system of claim 4, wherein the plurality of bend angles comprise one of a single fold along the linear PCB trenches or multiple folds or a curved fold.

6. The antenna system of claim 1, wherein the dielectric substrate comprises woven fiberglass cloth with an epoxy resin binder.

7. The antenna system of claim 1, wherein the planar PCB includes at least one of a radio, antennas, memory, or processor.

8. The antenna system of claim 1, wherein one or more PCB sections comprise an interface matrix or section of an interface matrix coupled to the plurality of antennas or antenna elements.

9. The antenna system of claim 1 wherein one or more PCB sections are bended to modify RF emission overlap from two or more antennas or antenna elements integrated on two or more PCB sections, and one or more parts of the PCB are configured to be removed to enable one or more PCB section bends.

10. A wireless access point comprising:
at least one radio with a plurality of radio chains;
an antenna system comprising:
a planar printed circuit board (PCB) with two or more PCB sections;
a dielectric substrate layer common to at least two PCB sections;
a plurality of antennas or antenna elements printed on two or more PCB sections;
means to couple radio frequency (RF) signals between at least two PCB sections using RF transmission lines;
means to interconnect antennas or antenna elements on one or more PCB sections to one or more radios; and
means to bend at least one PCB section relative to an adjacent PCB section in a range of angles from 0° to at least 90°,
wherein one or more of the PCB sections relative to other PCB sections is bended to radiate RF signals from a first radio chain into an RF signal coverage area different to or in common to an RF signal coverage area of at least one other of the plurality of radio chains.

11. The wireless access point of claim 10, further comprising means for maintaining one or bends at one or more bend angles in the PCB sections within the wireless access point.

12. The wireless access point of claim 11, wherein the bend angle of at least one PCB section relative to at least one other PCB section is manually or electronically adjusted to change the RF signal coverage area of the at least one radio.

13. A wireless-access point, comprising:
a radio comprising at least two radio-chain circuitry each configured to transmit respective radio frequency (RF) signals in a channel;
at least two planar antennas coupled with corresponding radio-chain circuitry to receive the RF signals,
wherein a first planar antenna is coupled with a first radio-chain circuitry of the radio to receive therefrom a first RF signal in the channel, the first planar antenna being arranged with its normal along a first direction, and configured to radiate the first RF signal along the first direction,
wherein a second planar antenna is coupled with a second radio-chain circuitry of the radio to receive therefrom a second RF signal in the channel, the second planar antenna being arranged with its normal along a second direction different from the first direction, and configured to radiate the second RF signal along the second direction, and
wherein the first planar antenna is printed on a first printed circuit board (PCB) section, the second planar antenna is printed on a second printed circuit board (PCB) section, at least one substrate layer is common to the first PCB section and the second PCB section.

14. The wireless-access point of claim 13, wherein the first PCB section and the second PCB section each comprise at least two dielectric substrates and at least four metal layers.

15. The wireless-access point of claim 13, wherein the first and second planar antenna are dual linear polarization microstrip patch antennas or printed inverted-F antennas or printed dipole antennas.

16. A printed circuit board (PCB) comprising:
two or more PCB sections separated by a PCB trench, wherein at least one substrate layer is common to the first PCB section and second PCB section and at least one other substrate layer is not common to first PCB section and second PCB section;
a plurality of antennas or antenna elements assembled or fabricated on the two or more PCB sections;
means to couple radio frequency (RF) signals between the at least two PCB sections using RF transmission lines; and
at least one PCB section oriented relative to an adjacent PCB section by a bend along a PCB trench while maintaining RF coupling between adjacent PCB sections.

17. An antenna system comprising:
a printed circuit board comprising:
two or more PCB sections separated by a PCB trench, wherein at least one substrate layer is common to the first PCB section and second PCB section and at least one other substrate layer is not common to first PCB section and second PCB section;
a plurality of antennas or antenna elements assembled or fabricated on the two or more PCB sections;
means to couple radio frequency (RF) signals between the at least two PCB sections using RF transmission lines; and
at least one PCB section oriented relative to an adjacent PCB section by a bend along a PCB trench while maintaining RF coupling between adjacent PCB sections; and
means to interconnect at least two PCB sections to one or more radios or radio chains.
